(19) United States
(12) Patent Application Publication
(10) Pub. No.: US 2023/0399450 A1
(43) Pub. Date: Dec. 14, 2023

(54) PREPARATION OF NON-POLAR-POLAR BLOCK COPOLYMERS VIA VINYL-TERMINATED POLYOLEFINS

(71) Applicant: Dow Global Technologies LLC, Midland, MI (US)

(72) Inventors: Zachary Kean, Midland, MI (US); Todd Senecal, Midland, MI (US); Rachel Brooner, Midland, MI (US)

(73) Assignee: Dow Global Technologies LLC, Midland, MI (US)

(21) Appl. No.: 18/252,250

(22) PCT Filed: Nov. 10, 2021
(86) PCT No.: PCT/US2021/058732

§ 371 Date: May 9, 2023

Related U.S. Application Data
(60) Provisional application No. 63/111,983, filed on Nov. 10, 2020.

(51) Int. Cl. C08F 293/00; C08F 4/76

(52) U.S. Cl. CPC C08F 293/005; C08F 4/76; C08F 2438/01

(57) ABSTRACT

This disclosure includes methods for preparing a non-polar-polar diblock copolymer. The method includes polymerizing one or more olefin monomers in the presence of an alkyl aluminum chain transfer agent to produce a polymeryl aluminum species, which is then heated to produce a vinyl-terminated polyolefin. A thiol compound is reacted with the vinyl terminated polyolefin to form a sulfide containing polyolefin intermediate. The thiol compound comprises a terminal hydroxyl or a protected terminal amine. A macroinitiator is produced by reacting the sulfide containing polyolefin intermediate with a linker, wherein the linker comprises an acyl halide and a halogen atom bonded to the alpha carbon to the acyl halide. Reacting the macroinitiator, a radical reagent, and CH₂═CH—(X) monomers via reversible-deactivation radical polymerization reaction produces the non-polar-polar diblock copolymer, where X is —C(O)OR, —CN, or —C(O)NHR, wherein R is chosen from —H, linear (C₁-C₁₈)alkyl, or branched (C₁-C₁₈)alkyl.

### TECHNICAL FIELD

Embodiments of the present disclosure generally relate to processes to produce non-polar-polar block copolymers using vinyl-terminal olefin polymers.

### BACKGROUND

Over the past few decades, block copolymers have emerged as a class of polymer materials with a wide range of technological applications. Due to the high tunability of their chemical structure (i.e., morphology, architecture and domain size), block copolymers have been utilized as surfactants, thermoplastic elastomers, nano-templates, membranes, etc.

Polyolefins are generally produced industrially via catalytic insertion (co)polymerization of ethylene and linear α-olefins on the scale of 70×10⁶ metric tons per year. The crystallinity of the polyolefin can be adjusted to achieve a variety of properties including, but not limited to, toughness, elasticity, and solvent resistance. Therefore, the incorporation of polyolefins into block copolymers would be of significant value. However, owing to the high oxophilicity of the early transition metal catalysts used in industrial polyolefin production, commercial polyolefin block copolymers have been limited to those including only non-polar comonomers. Hence, the preparation of functionalized block copolymers containing both polyolefins segments and polymer segments derived from polar comonomers remains a synthetic challenge.

In order to produce block copolymer containing a polyolefin segment, some researchers have synthesized functionalized vinyl polymers. Functionalized vinyl polymer may be produced by native molecular weight control based on catalyst or peroxide degradation of polypropylene. However, the reagents used to produce the functionalized vinyl polymers lack control, and thus, produce functionalized vinyl terminated polyolefin polymers with a wide range of molecular weight and low dispersity of the polyolefin block.

### SUMMARY

Ongoing needs exist to develop methods of producing high purity polyolefins with polar functionality such as, for example, non-polar-polar block copolymers. The methods needs to control the molecular weight or molecular weight distribution of the polyolefin, thus controlling the polyolefin block of the block copolymer. Additionally, the method needs to control the polar segment of the block copolymer.

Embodiments of this disclosure include methods for preparing a non-polar-polar diblock copolymer. The methods include polymerizing one or more olefin monomers in the presence of an alkyl aluminum chain transfer agent to produce a polymeryl aluminum species. The polymeryl aluminum species is heated to produce a vinyl-terminated polyolefin. A thiol compound is reacted with the vinyl-terminated polyolefin to form a sulfide-containing polyolefin intermediate, in which the thiol compound includes a terminal hydroxyl or a protected terminal amine. Reacting the sulfide-containing polyolefin intermediate with a linker produces a macroinitiator. The linker includes an acyl halide and a halogen atom bonded to the alpha carbon relative to the acyl halide. The macroinitiator, a radical reagent, and CH₂═CH—(X) monomers are reacted via reversible-deactivation radical polymerization reaction to produce the non-polar-polar diblock copolymer. In the CH₂═CH—(X) monomers, X is independently —C(O)OR, —CN, or —C(O)NHR, where R is chosen from —H, linear (C₁-C₁₈)alkyl, or branched (C₁-C₁₈)alkyl.

### BRIEF DESCRIPTION OF FIGURES

FIG. 1 is a spectrum of the proton NMR (¹H NMR) of a vinyl-terminated polyolefin.

FIG. 2A is a graph of the integral of the proton NMR (¹H NMR) signal of tert-butyl resonance from the polar block or the methylene (CH₂) resonance from the non-polar block as a function of the gradient²/1000.

FIG. 2B is the proton signal of tert-butyl resonance from the polar block and the proton signal of methylene (CH₂) resonance from the non-polar block.

### DETAILED DESCRIPTION

Unless otherwise defined, all technical and scientific terms used herein have the same meaning as commonly understood by one of ordinary skill in the art to which this disclosure belongs. In case of conflict, the specification, including definitions, will control.

Although methods and materials similar or equivalent to those described herein can be used in the practice or testing of various embodiments, suitable methods and materials are described herein.

Unless stated otherwise, all percentages, parts, ratios, etc., are by weight. When an amount, concentration, or other value or parameter is given as either a range, preferred range, or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having,” or any other variation thereof, are intended to cover a non-exclusive inclusion. For example, a process, method, article, or apparatus that comprises a list of elements is not necessarily limited to those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the disclosure. Where applicants have defined an embodiment or a portion thereof with an open-ended term such as “comprising,” unless otherwise stated, the description should be interpreted to also describe such an embodiment using the term “consisting essentially of.”

Use of “a” or “an” are employed to describe elements and components of various embodiments. This is merely for convenience and to give a general sense of the various embodiments. This description should be read to include one or at least one and the singular also includes the plural unless it is obvious that it is meant otherwise.

The term “polymer” refers to a compound prepared by polymerizing monomers, whether of the same or a different type. The generic term polymer thus embraces the terms “homopolymer” and “copolymer.” The term “homopolymer” refers to polymers prepared from only one type of monomer; the term “copolymer” refers to polymers prepared from two or more different monomers, and for the purpose of this disclosure may include “terpolymers” and “interpolymer.”

The term “block copolymer” refers to a multi-block interpolymer and includes one or more monomers in polymerized form, characterized by multiple blocks or segments of two or more polymerized monomer units, the blocks or segments differing in chemical or physical properties. Specifically, the term “block copolymer” refers to a polymer comprising two or more chemically distinct regions or segments (referred to as “blocks”) joined in a linear manner. A “diblock copolymer” includes only two blocks or segments. For example a diblock copolymer may include a polyethylene segment and a polyacrylamide segment. Block copolymers may be characterized by unique distributions of both polymer dispersity (Ð or Mw/Mn). The term “diblock copolymer” refers to a copolymer having two chemically distinct regions or segments joined in a linear manner.

In one or more embodiments, the non-polar-polar diblock copolymer include two blocks or segments, a non-polar block and a polar block. In some embodiments, the non-polar block is a polyolefin. The polyolefin may be an ethylene homopolymer or an ethylene/α-olefin copolymer. In some embodiments, the polar block includes polyacrylate copolymer. In various embodiments, the polar block include units derived from acrylate monomers, t-butyl acrylate, tert-butyl acrylate, acrylamide, acrylonitrile, vinyl acetate. In one or more embodiments, the non-polar-polar diblock copolymer is a polyethylene-polyacrylate diblock copolymer.

The term “chain transfer agent” refers to a compound or mixture of compounds that is capable of causing reversible or irreversible polymeryl exchange with active catalyst sites. Irreversible chain transfer refers to a transfer of a growing polymer chain from the active catalyst to the chain transfer agent that results in termination of polymer chain growth. Reversible chain transfer refers to transfers of growing polymer chain back and forth between the active catalyst and the chain transfer agent. The term “polymeryl” refers to a polymer missing one hydrogen atom on the carbon at the point of attachment, for example to the aluminum from the chain transfer agent.

Embodiments of this disclosure include methods for preparing a non-polar-polar diblock copolymer. The methods include polymerizing one or more olefin monomers in the presence of an alkyl aluminum chain transfer agent to produce a polymeryl aluminum species, which is then heated to produce a vinyl-terminated polyolefin. A thiol compound is reacted with the vinyl-terminated polyolefin to form a sulfide-containing polyolefin intermediate. A macroinitiator is produced by reacting the sulfide-containing polyolefin intermediate with a linker. The macroinitiator, a radical reagent, and CH₂═CH—(X) monomers are reacted via reversible-deactivation radical polymerization reaction to produce the non-polar-polar diblock copolymer.

In one or more embodiments, olefin monomers polymerized in the presence of an alkyl aluminum chain transfer agent include (C₂-C₁₂)α-olefin monomers. In some embodiments, the olefin monomers include ethylene, propylene, 1-butene, 1-pentene, 1-hexene, 1-heptene, 1-octene, 1-nonene, 1-decene, 1-undecene, 1-decadene. In various embodiments, the olefin monomers are ethylene and 1-octene; ethylene and 1-hexene; ethylene and 1-butene; or ethylene and propylene.

In various embodiments, olefin monomers polymerized in the presence of an alkyl aluminum chain transfer agent, in which the alkyl aluminum chain transfer agent is AlR₃, where each R is independently (C₁-C₁₂)alkyl. In some embodiments, R is methyl, ethyl, n-propyl, 2-propyl, n-butyl, tert-butyl, iso-butyl, pentyl, hexyl, heptyl, n-octyl, tert-octyl, nonyl, decyl, undecyl, or dodecyl. Non-limiting examples of the alkyl aluminum chain transfer agent include triethyl aluminum, tri(i-propyl) aluminum, tri(i-butyl) aluminum, tri(n-hexyl) aluminum, and tri(n-octyl) aluminum.

The methods of this disclosure include polymerizing one or more olefin monomers in the presence of an alkyl aluminum chain transfer agent to produce a polymeryl aluminum species. The alkyl aluminum functions as a chain transfer agent, which results in the formation of polymeryl aluminum species. Upon heating the polymeryl aluminum species, the vinyl-terminated polyolefin is produced. The vinyl-terminated polyolefin may be formed via a beta-hydride elimination reaction.

The process for preparing a polyolefin component that includes vinyl-terminated polyolefin according to formula A¹L¹. The process includes combining ethylene and optionally one or more (C₃-C₁₂)α-olefin monomer, the alkyl aluminum chain transfer agent, and a catalyst component comprising a procatalyst to form a solution and polymerizing from greater than 10 mol % to less than or equal to 99 mol % of the ethylene and α-olefin monomers in the solution. The solution is heated to a temperature of at least 160° C. and holding the solution at the temperature of at least 160° C. for a time of at least 30 seconds; and a product is recovered. The product includes the polyolefin component comprising the unsaturated polyolefin of the formula A¹L¹.

In the formula A¹L¹, L¹ is a polyolefin; and A¹ is selected from the group consisting of a vinyl group, a vinylidene group of the formula CH₂═C(Y¹)—, a vinylene group of the formula Y¹CH═CH—, a mixture of a vinyl group and a vinylene group of the formula Y¹CH═CH—, a mixture of a vinyl group and a vinylidene group of the formula CH₂═C(Y¹)—, a mixture of a vinylidene group of the formula CH₂═C(Y¹)— and a vinylene group of the formula Y¹CH═CH—, and a mixture of a vinyl group, a vinylidene group of the formula CH₂═C(Y¹)—, and a vinylene group of the formula Y¹CH═CH—. Each Y¹ is a C₁ to C₃₀ hydrocarbyl group; and the unsaturated polyolefin of the formula A¹L¹ comprises a weight average molecular weight from 1,000 to 10,000,000 g/mol.

Without being bound by any particular theory, the alkyl aluminum chain transfer agent contributes to the formation of the unsaturated polyolefin of the formula A¹L¹.

The molecular weight of the diblock copolymer is varied by the amount of chain transfer agent added to the polyolefin polymerization reaction. For example, if the amount of chain transfer agent is increased, the molecular weight will decrease when compared to a polymer composition that was polymerized in the presence of a lesser amount of chain transfer agent.

Scheme 1 illustrates a synthetic procedure according to embodiments of this disclosure. In Scheme 1, Compound 1 is a vinyl-terminated polyolefin produced by the method previously described. Compound 1 is mixed with a thiol compound to form Compound 2, a sulfide-containing polyolefin intermediate. Compound 2 reacts with a linker to form a macroinitiator, Compound 3. Compound 3, a radical reagent, and CH₂═CH—(X) monomers (i.e. t-butyl acrylate and n-butyl acrylate) are reacted via a reversible-deactivation radical polymerization to produce Compound 4, the non-polar-polar diblock copolymer. In an optional reaction, the tert-butyl group of the units derived from tert-butyl acrylate are removed via the addition of acid to the reaction or via a thermal reaction to produce an acid non-polar-polar diblock copolymer.

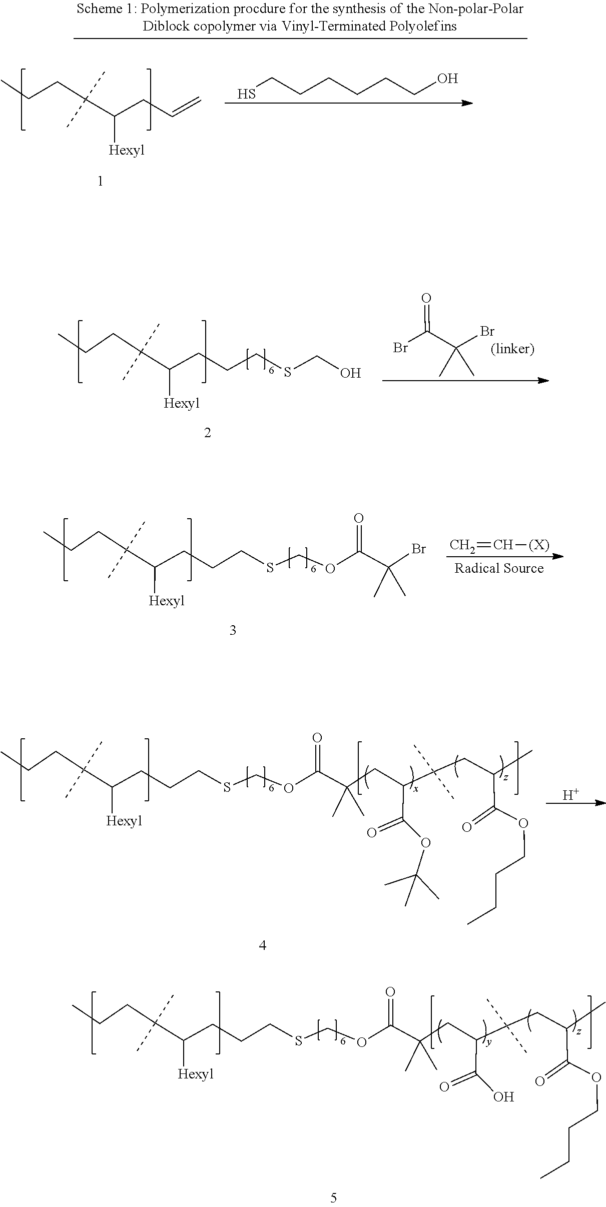

The phrase “reversible-deactivation radical polymerization” refers to a radical polymerization reaction controlled by a radical reagent. The radical reagent affects the rate of polymer propagation and site of polymer propagation. Reversible-deactivation radical polymerization differs from conventional radical polymerization because of the ability of a metal complex to control the steady-state concentration of propagating radicals. By controlling the concentration of the propagating radicals, the rate of termination by combination of propagating radicals is disproportionate to the rate of propagation. By controlling the rate and placement of radical propagation, the amount of branching is controlled also.

In one or more embodiments, the methods of this disclosure further include reacting the non-polar-polar diblock copolymer under thermal or acidic conditions to form non-polar-polar acid diblock copolymer. The non-polar-polar acid diblock copolymer is Compound 5 as illustrated in Scheme 1. Reacting the non-polar-polar diblock copolymer under thermal or acidic conditions removes the tert-butyl group from the units derived from tert-butyl acrylate monomers in the non-polar-polar diblock copolymer. The phrase “thermal conditions” refers to the amount of energy (i.e. heat) necessary in an endothermic reaction to result in the reaction products. In some embodiments, the thermal conditions include a temperature greater than 20° C. In various embodiment, the thermal conditions includes temperatures from greater than 30° C., greater than 40° C., or greater than 50° C. In other embodiments, the thermal conditions include a temperature of from 20° C. to 190° C.

As shown in Scheme 1, in some embodiments, the thiol compound includes a thiol group (—SH) and a terminal hydroxyl group (—OH). In other embodiments, the thiol compound includes a thiol group and a protected terminal amine —(NHR). Terminal amines are reactive with many groups, including a vinyl group. To prevent the terminal amine from reacting with the vinyl group in the vinyl-terminal polyolefin (for example Compound 1) instead of with the thiol group, the terminal amine may include a protecting group. Because the protecting group is not considered to alter the “terminal functionality” of the terminal amine, as used herein, unless clearly stated to the term “terminal amine” is considered to encompass a terminal amine with a protecting group.

In some embodiments, the thiol compound has a structure according to formula (I):

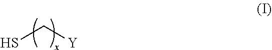

In formula (I), subscript x is 2 to 12; and Y is —NHR^{B} or —OH, wherein R^{B} is a protecting group. The protecting group may be derived from BOC-anhydride (di-tert-butyl dicarbonate) to from a BOC-protected amine (—NHBOC). In one or more embodiments, the terminal amine protecting group may include FMOC (9-fluorenylmethyl carbamate), BOC (t-butyl carbamate), Cbz (benzyl carbamate), trifluoroacetamide, and phthalimide.

In some embodiments, when the thiol compound includes a protected terminal amine, the method further includes deprotecting the protected terminal amine after reacting the thiol compound with the vinyl-terminated polyolefin.

In embodiments, the thiol compound is reacted with the vinyl-terminated polyolefin to form a sulfide-containing polyolefin intermediate. In some embodiments, the thiol group (—SH) of the thiol compound reacts with the terminal vinyl group of the vinyl-terminated polyolefin to produce the sulfide-containing polyolefin intermediate.

In embodiments, the macroinitiator is produced by reacting the sulfide-containing polyolefin intermediate with a linker. In some embodiments, the macroinitiator is formed via an esterification or amidation reaction of the linker. In one or more embodiments, the linker includes an acyl halide and a halogen atom on the alpha carbon relative to the acyl halide. In some embodiments, the alpha halogen atom of the linker is bromine or iodine.

In some embodiments, the linker has a structure according to formula (II):

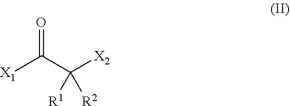

In formula (II), X₁ is a halogen atom, X₂ is chlorine, bromine or iodine. R¹ and R² are independently (C₁-C₂₀)hydrocarbyl. In some embodiments, R¹ and R² are independently (C₁-C₁₂)alkyl. In various embodiments, R¹ and R² are independently methyl, ethyl, propyl, n-butyl, pentyl, hexyl, heptyl, octyl, nonyl, or decyl. In one or more embodiments, R¹ and R² are independently —(CH₂)ₙ[(C₆-C₂₀)aryl], where subscript n is 1 to 10. In some embodiments, R¹ and R² are independently (C₆-C₂₀)aryl.

In embodiments, the methods for preparing a non-polar-polar diblock copolymer further include reacting the macroinitiator, a radical reagent, and CH₂═CH—(X) monomers via a reversible-deactivation radical polymerization reaction to produce the non-polar-polar diblock copolymer. In the CH₂═CH—(X) monomers, X is independently —C(O)OR, —CN, or —C(O)NHR, where R is chosen from —H, linear (C₁-C₁₈)alkyl, or branched (C₁-C₁₈)alkyl.

In one or more embodiments, the acrylate monomers comprise CH₂═CHC(O)(OR), glycidyl acrylate, or combination thereof, where each R is chosen from —H, linear (C₁-C₁₈)alkyl, or branched (C₁-C₁₈)alkyl. In some embodiments, the acrylate monomers comprise at least one t-butyl acrylate.

In various embodiments, the radical reagent comprises CuX, Fe(III)X₃, and Ru(III)X₃ wherein each X is a ligand selected from the group consisting of 2,2′:6′,2″-terpyridine (tpy), 2,2′-bipyridine (bpy), 4,4′-di(5-nonyl)-2,2′-bipyridine (dNbpy), N,N,N′,N′-tetramethylethylenediamine (TMEDA), N-propyl(2-pyridyl)methanimine (NPrPMI), 4,4′,4″-tris(5-nonyl)-2,2′:6′,2″-terpyridine (tNtpy), N,N,N′,N″,N″-pentamethyldiethylenetriamine (PMDETA), N,N-bis(2-pyridylmethyl)octylamine (BPMOA), 1,1,4,7,10,10-hexamethyltriethylenetetramine (HMTETA), tris[2-(dimethylamino)ethyl]amine (Me₆TREN), tris[(2-pyridyl)methyl]amine (TPMA), 1,4,8,11-tetraaza-1,4,8,11-tetramethylcyclotetradecane (Me4CYCLAM), and N,N,N′,N′-tetrakis(2-pyridylmethyl)ethylenediamine (TPEN).

In one or more embodiments, the radical reagent comprises copper(I) halide, wherein the halide is bromine, chlorine, or iodine. In some embodiments, the radical reagent is copper(I) bromide.

In one or more embodiments, the non-polar block of the non-polar-polar diblock copolymer is polyolefin. In some embodiments, the non-polar block is polyethylene copolymer. In various embodiments, the non-polar-polar diblock copolymer includes at least 40% by weight (or weight percent) of the non-polar block. In some embodiments, the non-polar-polar diblock copolymer includes at least 50% by weight of the non-polar block.

In one or more embodiments, the non-polar block of the non-polar-polar diblock copolymer has a number average molecular weight number (Mₙ) from 1.0 to 35 kDa. In some embodiments, the non-polar block of the non-polar-polar diblock copolymer has a Mₙ of 1.0 to 30. In various embodiments, the non-polar block of the non-polar-polar diblock copolymer has a Mₙ of 1.0 to 20.

In one or more embodiments, the polar block of the non-polar-polar diblock copolymer is polyacrylate. In various embodiments, the non-polar-polar diblock copolymer includes from 10% to 60% by weight (or weight percent) of the polar block.

In one or more embodiments, the non-polar-polar diblock copolymer has a number average molecular weight number (Mₙ) from 1.0 to 60 kDa.

### Catalyst System

In further embodiments of this disclosure, olefin monomers are polymerized in the presence of a chain transfer agent and a catalyst system to produce the vinyl-terminated polyolefin. The catalyst system includes one or more procatalyst.

In further embodiments, the catalyst system includes the procatalyst and a co-catalyst, whereby an active catalyst is formed by the combination of the procatalyst and the co-catalyst. In these embodiments, the catalyst system may include a ratio of the procatalyst to the co-catalyst of 1:2, or 1:1.5, or 1:1.2.

The catalyst system may include a procatalyst. The procatalyst may be rendered catalytically active by contacting the complex to, or combining the complex with, a metallic activator having anion of the procatalyst and a countercation. The procatalyst may be chosen from a Group IV metal-ligand complex (Group IVB according to CAS or Group 4 according to IUPAC naming conventions), such as a titanium (Ti) metal-ligand complex, a zirconium (Zr) metal-ligand complex, or a hafnium (Hf) metal-ligand complex. Non-limiting examples of the procatalyst include catalysts, procatalysts, or catalytically active compounds for polymerizing ethylene-based polymers are disclosed in one or more of U.S. Pat. No. 8,372,927; WO 2010022228; WO 2011102989; U.S. Pat. Nos. 6,953,764; 6,900,321; WO 2017173080; U.S. Pat. Nos. 7,650,930; 6,777,509 WO 99/41294; U.S. Pat. No. 6,869,904; or WO 2007136496, all of which documents are incorporated herein by reference in their entirety.

Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,858,706 B2, 7,355,089 B2, 8,058,373 B2, and 8,785,554 B2. With reference to the paragraphs below, the term “procatalyst” is interchangeable with the terms “catalyst,” “precatalyst,” “catalyst precursor,” “transition metal catalyst,” “transition metal catalyst precursor,” “polymerization catalyst,” “polymerization catalyst precursor,” “transition metal complex,” “transition metal compound,” “metal complex,” “metal compound,” “complex,” and “metal-ligand complex,” and like terms.

In one or more embodiments, the Group IV metal-ligand procatalyst complex includes a bis(phenylphenoxy) Group IV metal-ligand complex or a constrained geometry Group IV metal-ligand complex.

According to some embodiments, the Group IV metal-ligand procatalyst complex may include a bis(phenylphenoxy) compound according to formula (X):

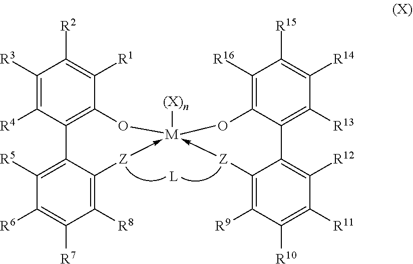

In formula (X), M is a metal chosen from titanium, zirconium, or hafnium, the metal being in a formal oxidation state of +2, +3, or +4. Subscript n of (X)ₙ is 0, 1, or 2. When subscript n is 1, X is a monodentate ligand or a bidentate ligand, and when subscript n is 2, each X is a monodentate ligand. L is a diradical selected from the group consisting of (C₁-C₄₀)hydrocarbylene, (C₁-C₄₀)heterohydrocarbylene, —Si(R^{C})₂—, —Si(R^{C})₂OSi(R^{C})₂—, —Si(R^{C})₂C(R^{C})₂—, —Si(R^{C})₂Si(R^{C})₂—, —Si(R^{C})₂C(R^{C})₂Si(R^{C})₂—, —C(R^{C})₂Si(R^{C})₂C(R^{C})₂—, —N(R^{N})C(R^{C})₂—, —N(R^{N})N(R^{N})—, —C(R^{C})₂N(R^{N})C(R^{C})₂—, —Ge(R^{C})₂—, —P(R^{P})—, —N(R^{N})—, —O—, —S—, —S(O)—, —S(O)₂—, —N═C(R^{C})—, —C(O)O—, —OC(O)—, —C(O)N(R)—, and —N(R^{c})C(O)—. Each Z is independently chosen from —O—, —S—, —N(R^{N})—, or —P(R^{P})—; R²-R⁴, R⁵-R⁸, R⁹-R¹² and R¹³-R¹⁵ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen. R¹ and R¹⁶ are selected from radicals having formula (XI), radicals having formula (XII), and radicals having formula (XIII):

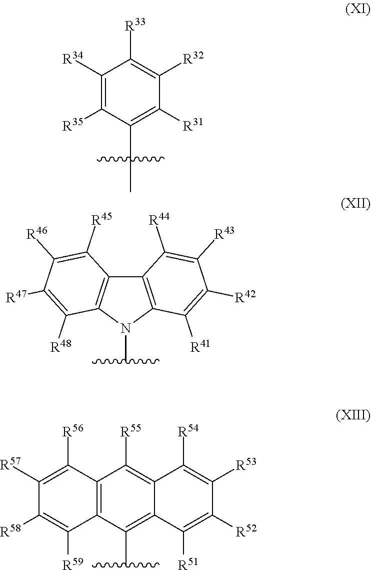

In formulas (XI), (XII), and (XIII), each of R³¹-R³⁵, R⁴¹-R⁴⁸, and R⁵¹-R⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{c}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In one or more embodiments, each X can be a monodentate ligand that, independently from any other ligands X, is a halogen, unsubstituted (C₁-C₂₀)hydrocarbyl, unsubstituted (C₁-C₂₀)hydrocarbylC(O)O—, or R^{K}R^{L}N—, wherein each of R^{K} and R^{L} independently is an unsubstituted(C₁-C₂₀)hydrocarbyl.

Illustrative bis(phenylphenoxy) metal-ligand complexes according to formula (X) include, for example:
(2′,2″-(propane-1,3-diylbis(oxy))bis(5′-chloro-3-(3,6-di-tert-octyl-9H-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-3′-chloro-5-(2,4,4-trimethylpentan-2-yl)biphenyl-2-ol)dimethyl-hafnium;
(2′,2″-(propane-1,3-diylbis(oxy))bis(3′-chloro-3-(3,6-di-tert-butyl-9H-carbazol-9-yl)-5′-fluoro-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(5′-cyano-3-(3,6-di-tert-butyl-9H-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(5′-dimethylamino-3-(3,6-di-tert-butyl-9H-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(3′,5′-dimethyl-3-(3,6-di-tert-butyl-9H-carbazol-9-yl)-5-(2,4,4-trimethylpentan-2-yl)biphenyl-2-ol)dimethyl-hafnium;
(2′,2″-(propane-1,3-diylbis(oxy))bis(5′-chloro-3-(3,6-di-tert-butyl-9H-carbazol-9-yl)-3′-ethyl-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-3′-methyl-5′-tert-butyl-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-5′-fluoro-3′-methyl-5-(2,4,4-trimethylpentan-2-yl)biphenyl-2-ol)dimethyl-hafnium;
(2′,2″-(propane-1,3-diylbis(oxy))bis(3-(9H-carbazol-9-yl)-5′-chloro-3′-methyl-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-3′-methyl-5′-trifluoromethyl-5-(2,4,4-trimethylpentan-2-yl)biphenyl-2-ol)dimethyl-hafnium;
(2′,2″-(2,2-dimethyl-2-silapropane-1,3-diylbis(oxy))bis(3′,5′-dichloro-3-(3,6-di-tert-butyl-9H-carbazol-9-yl)-5-(2,4,4-trimethylpentan-2-yl)biphenyl-2-ol)dimethyl-hafnium;
(2′2″-(2,2-dimethyl-2-silapropane-1-diylbis(oxy))bis(5′-chloro-3-(3,6-di-tert-butyl-9-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(3′-bromo-5′-chloro-3-(3,6-di-tert-butyl-9H-carbazol-9-yl)-5-(2,4,4-trimethylpentan-2-yl)biphenyl-2-ol)dimethyl-hafnium;
(2′,2″-(propane-1,3-diylbis(oxy))-(5′-chloro-3-(3,6-di-tert-butyl-9H-carbazol-9-yl)-3′-fluoro-5-(2,4,4-trimethylpentan-2-yl)biphenyl-2-ol)-(3″,5″-dichloro-3-(3,6-di-tert-butyl-9H-carbazol-9-yl)-5-(2,4,4-trimethylpentan-2-yl)biphenyl-2-ol)dimethyl-hafnium;
(2′,2″-(propane-1,3-diylbis(oxy))bis(3-(3,6-di-tert-butyl-9H-carbazol-9-yl)-5′-fluoro-3′-trifluoromethyl-5-(2,4,4-trimethylpentan-2-yl)biphenyl-2-ol)dimethyl-hafnium;
(2′,2″-(butane-1,4-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-hafnium;
(2′,2″-(ethane-1,2-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-hafnium;
(2′,2″-(propane-1,3-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-zirconium;
(2′,2″-(propane-1,3-diylbis(oxy))bis(3-(3,6-di-tert-butyl-9H-carbazol-9-yl)-3′,5′-dichloro-5-(2,4,4-trimethylpentan-2-yl)biphenyl-2-ol)dimethyl-titanium; and
(2′,2″-(propane-1,3-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-titanium.

Other bis(phenylphenoxy) metal-ligand complexes that may be used in combination with the metallic activators in the catalyst systems of this disclosure will be apparent to those skilled in the art.

According to some embodiments, the Group IV metal-ligand complex may include a cyclopentadienyl procatalyst according to formula (XIV):

LpᵢMXₘX′ₙX″ₚ, or a dimer thereof (XIV).

In formula (XIV), Lp is an anionic, delocalized, π-bonded group that is bound to M, containing up to 50 non-hydrogen atoms. In some embodiments of formula (XIV), two Lp groups may be joined together forming a bridged structure, and further optionally one Lp may be bound to X.

In formula (XIV), M is a metal of Group 4 of the Periodic Table of the Elements in the +2, +3 or +4 formal oxidation state. X is an optional, divalent substituent of up to 50 non-hydrogen atoms that together with Lp forms a metallocycle with M. X is an optional neutral ligand having up to 20 non hydrogen atoms; each X″ is independently a monovalent, anionic moiety having up to 40 non-hydrogen atoms. Optionally, two X″ groups may be covalently bound together forming a divalent dianionic moiety having both valences bound to M, or, optionally two X″ groups may be covalently bound together to form a neutral, conjugated or nonconjugated diene that is π-bonded to M, in which M is in the +2 oxidation state. In other embodiments, one or more X″ and one or more X′ groups may be bonded together thereby forming a moiety that is both covalently bound to M and coordinated thereto by means of Lewis base functionality. Subscript i of Lpᵢ is 0, 1, or 2; subscript n of X′ₙ is 0, 1, 2, or 3; subscript m of Xₘ is 0 or 1; and subscript p of X″ₚ is 0, 1, 2, or 3. The sum of i+m+p is equal to the formula oxidation state of M.

Illustrative Group IV metal-ligand complexes may include cyclopentadienyl procatalyst that may be employed in the practice of the present invention include:
cyclopentadienyltitaniumtrimethyl; cyclopentadienyltitaniumtriethyl; cyclopentadienyltitaniumtriisopropyl; cyclopentadienyltitaniumtriphenyl; cyclopentadienyltitaniu mtribenzyl; cyclopentadienyltitanium-2,4-dimethylpentadienyl; cyclopentadienyltitanium-2,4-dimethylpentadienyl•triethylphosphine; cyclopentadienyltitanium-2,4-dimethylpentadienyl•trimethylphosphine; cyclopentadienyltitaniumdimethylmethoxide; cyclopentadienyltitaniumdimethylchloride; pentamethylcyclopentadienyltitaniumtrimethyl; indenyltitaniumtrimethyl; indenyltitaniumtriethyl; indenyltitaniumtripropyl; indenyltitaniumtriphenyl; tetrahydroindenyltitaniumtribenzyl; pentamethylcyclopentadienyltitaniumtriisopropyl; pentamethylcyclopentadienyltitaniumtribenzyl; pentamethylcyclopentadienyltitaniumdimethylmethoxide; pentamethylcyclopentadienyltitaniumdimethylchloride; bis(η⁵-2,4-dimethylpentadienyl)titanium; bis(η⁵-2,4-dimethylpentadienyl)titanium•trimethylphosphine; bis(η⁵-2,4-dimethylpentadienyl)titanium•triethylphosphine; octahydrofluorenyltitaniumtrimethyl; tetrahydroindenyltitaniumtrimethyl; tetrahydrofluorenyltitaniumtrimethyl; (tert-butylamido)(1,1-dimethyl-2,3,4,9,10-η-1,4,5,6,7,8-hexahydronaphthalenyl)dimethylsilanetitaniumdimethyl; (tert-butylamido)(1,1,2,3-tetramethyl-2,3,4,9,10-η-1,4,5,6,7,8-hexahydronaphthalenyl)dimethylsilanetitaniumdimethyl; (tert-butylamido)(tetramethyl-η⁵-cyclopentadienyl) dimethylsilanetitanium dibenzyl; (tert-butylamido)(tetramethyl-η⁵-cyclopentadienyl)dimethylsilanetitanium dimethyl; (tert-butylamido)(tetramethyl-η⁵-cyclopentadienyl)-1,2-ethanediyltitanium dimethyl; (tert-butylamido)(tetramethyl-η⁵-indenyl)dimethylsilanetitanium dimethyl; (tert-butylamido)(tetramethyl-η⁵-cyclopentadienyl)dimethylsilane titanium (III) 2-(dimethylamino)benzyl; (tert-butylamido)(tetramethyl-η⁵-cyclopentadienyl)dimethylsilanetitanium (III) allyl; (tert-butylamido)(tetramethyl-η⁵-cyclopentadienyl)dimethylsilanetitanium (III) 2,4-dimethylpentadienyl; (tert-butylamido)(tetramethyl-η⁵-cyclopentadienyl)dimethylsilanetitanium (II) 1,4-diphenyl-1,3-butadiene;
(tert-butylamido)(tetramethyl-η⁵-cyclopentadienyl)dimethylsilanetitanium (II) 1,3-pentadiene; (tert-butylamido)(2-methylindenyl)dimethylsilanetitanium (II) 1,4-diphenyl-1,3-butadiene; (tert-butylamido)(2-methylindenyl)dimethylsilanetitanium (II) 2,4-hexadiene; (tert-butylamido)(2-methylindenyl)dimethylsilanetitanium (IV) 2,3-dimethyl-1,3-butadiene; (tert-butylamido)(2-methylindenyl)dimethylsilanetitanium (IV) isoprene; (tert-butylamido)(2-methylindenyl)dimethylsilanetitanium (IV) 1,3-butadiene; (tert-butylamido)(2,3-dimethylindenyl)dimethylsilanetitanium (IV) 2,3-dimethyl-1,3-butadiene; (tert-butylamido)(2,3-dimethylindenyl)dimethylsilanetitanium (IV) isoprene; (tert-butylamido)(2,3-dimethylindenyl)dimethylsilanetitanium (IV) dimethyl; (tert-butylamido)(2,3-dimethylindenyl)dimethylsilanetitanium (IV) dibenzyl; (tert-butylamido)(2,3-dimethylindenyl)dimethylsilanetitanium (IV) 1,3-butadiene; (tert-butylamido)(2,3-dimethylindenyl)dimethylsilanetitanium (II) 1,3-pentadiene; (tert-butylamido)(2,3-dimethylindenyl)dimethylsilanetitanium (II) 1,4-diphenyl-1,3-butadiene; (tert-butylamido)(2-methylindenyl)dimethylsilanetitanium (II) 1,3-pentadiene; (tert-butylamido)(2-methylindenyl)dimethylsilanetitanium (IV) dimethyl; (tert-butylamido)(2-methylindenyl)dimethylsilanetitanium (IV) dibenzyl; (tert-butylamido)(2-methyl-4-phenylindenyl)dimethylsilanetitanium (II) 1,4-diphenyl-1,3-butadiene; (tert-butylamido)(2-methyl-4-phenylindenyl)dimethylsilanetitanium (II) 1,3-pentadiene; (tert-butylamido)(2-methyl-4-phenylindenyl)dimethylsilanetitanium (II) 2,4-hexadiene; (tert-butylamido)(tetramethyl-η⁵-cyclopentadienyl)dimethyl-silanetitanium (IV) 1,3-butadiene; (tert-butylamido)(tetramethyl-η⁵-cyclopentadienyl)dimethylsilanetitanium (IV) 2,3-dimethyl-1,3-butadiene; (tert-butylamido)(tetramethyl-η⁵-cyclopentadienyl)dimethylsilanetitanium (IV) isoprene; (tert-butylamido)(tetramethyl-η⁵-cyclopentadienyl)dimethyl-silanetitanium (II) 1,4-dibenzyl-1,3-butadiene; (tert-butylamido)(tetramethyl-η⁵-cyclopentadienyl)dimethylsilanetitanium (II) 2,4-hexadiene; (tert-butylamido)(tetramethyl-η⁵-cyclopentadienyl)dimethyl-silanetitanium (II) 3-methyl-1,3-pentadiene; (tert-butylamido)(2,4-dimethylpentadien-3-yl)dimethylsilanetitaniumdimethyl; (tert-butylamido)(6,6-dimethylcyclohexadienyl)dimethylsilanetitaniumdimethyl; (tert-butylamido)(1,1-dimethyl-2,3,4,9,10-η-1,4,5,6,7,8-hexahydronaphthalen-4-yl)dimethylsilanetitaniumdimethyl; (tert-butylamido)(1,1,2,3-tetramethyl-2,3,4,9,10-η-1,4,5,6,7,8-hexahydronaphthalen-4-yl)dimethylsilanetitaniumdimethyl; (tert-butylamido)(tetramethyl-η⁵-cyclopentadienyl methylphenylsilanetitanium (IV) dimethyl; (tert-butylamido)(tetramethyl-η⁵-cyclopentadienyl methylphenylsilanetitanium (II) 1,4-diphenyl-1,3-butadiene; 1-(tert-butylamido)-2-(tetramethyl-η⁵-cyclopentadienyl)ethanediyltitanium (IV) dimethyl; 1-(tert-butylamido)-2-(tetramethyl-η⁵-cyclopentadienyl)ethanediyl-titanium (II) 1,4-diphenyl-1,3-butadiene;
Each of the illustrative cyclopentadienyl procatalyst may include zirconium or hafnium in place of the titanium metal centers of the cyclopentadienyl procatalyst.

Other procatalysts, especially procatalysts containing other Group IV metal-ligand complexes, will be apparent to those skilled in the art.

Both heterogeneous and homogeneous catalysts may be employed. Examples of heterogeneous catalysts include the well known Ziegler-Natta compositions, especially Group 4 metal halides supported on Group 2 metal halides or mixed halides and alkoxides and the well known chromium or vanadium based catalysts. Preferably, the catalysts for use herein are homogeneous catalysts comprising a relatively pure organometallic compound or metal complex, especially compounds or complexes based on metals selected from Groups 3-10 or the Lanthanide series of the Periodic Table of the Elements.

Metal complexes for use herein may be selected from Groups 3 to 15 of the Periodic Table of the Elements containing one or more delocalized, π-bonded ligands or polyvalent Lewis base ligands. Examples include metallocene, half-metallocene, constrained geometry, and polyvalent pyridylamine, or other polychelating base complexes. The complexes are generically depicted by the formula: MKₖXₓZ_{z}, or a dimer thereof, wherein M is a metal selected from Groups 3-15, preferably 3-10, more preferably 4-10, and most preferably Group 4 of the Periodic Table of the Elements; K independently at each occurrence is a group containing delocalized π-electrons or one or more electron pairs through which K is bound to M, said K group containing up to 50 atoms not counting hydrogen atoms, optionally two or more K groups may be joined together forming a bridged structure, and further optionally one or more K groups may be bound to Z, to X or to both Z and X; X independently at each occurrence is a monovalent, anionic moiety having up to 40 non-hydrogen atoms, optionally one or more X groups may be bonded together thereby forming a divalent or polyvalent anionic group, and, further optionally, one or more X groups and one or more Z groups may be bonded together thereby forming a moiety that is both covalently bound to M and coordinated thereto; or two X groups together form a divalent anionic ligand group of up to 40 non-hydrogen atoms or together are a conjugated diene having from 4 to 30 non-hydrogen atoms bound by means of delocalized π-electrons to M, whereupon M is in the +2 formal oxidation state, and Z independently at each occurrence is a neutral, Lewis base donor ligand of up to 50 non-hydrogen atoms containing at least one unshared electron pair through which Z is coordinated to M; k is an integer from 0 to 3; x is an integer from 1 to 4; z is a number from 0 to 3; and the sum, k+x, is equal to the formal oxidation state of M.

Suitable metal complexes include those containing from 1 to 3 π-bonded anionic or neutral ligand groups, which may be cyclic or non-cyclic delocalized π-bonded anionic ligand groups. Exemplary of such π-bonded groups are conjugated or nonconjugated, cyclic or non-cyclic diene and dienyl groups, allyl groups, boratabenzene groups, phosphole, and arene groups. By the term “π-bonded” is meant that the ligand group is bonded to the transition metal by a sharing of electrons from a partially delocalized π-bond.

Each atom in the delocalized π-bonded group may independently be substituted with a radical selected from the group consisting of hydrogen, halogen, hydrocarbyl, halohydrocarbyl, hydrocarbyl-substituted heteroatoms wherein the heteroatom is selected from Group 14-16 of the Periodic Table of the Elements, and such hydrocarbyl-substituted heteroatom radicals further substituted with a Group 15 or 16 hetero atom containing moiety. In addition, two or more such radicals may together form a fused ring system, including partially or fully hydrogenated fused ring systems, or they may form a metallocycle with the metal. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. Suitable hydrocarbyl-substituted heteroatom radicals include mono-, di- and tri-substituted radicals of boron, silicon, germanium, nitrogen, phosphorus or oxygen wherein each of the hydrocarbyl groups contains from 1 to 20 carbon atoms. Examples include N,N-dimethylamino, pyrrolidinyl, trimethylsilyl, triethylsilyl, t-butyldimethylsilyl, methyldi(t-butyl)silyl, triphenylgermyl, and trimethylgermyl groups. Examples of Group 15 or 16 hetero atom containing moieties include amino, phosphino, alkoxy, or alkylthio moieties or divalent derivatives thereof, for example, amide, phosphide, alkyleneoxy or alkylenethio groups bonded to the transition metal or Lanthanide metal, and bonded to the hydrocarbyl group, π-bonded group, or hydrocarbyl-substituted heteroatom.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, phosphole, and boratabenzyl groups, as well as inertly substituted derivatives thereof, especially C₁₋₁₀ hydrocarbyl-substituted or tris(C₁₋₁₀ hydrocarbyl)silyl-substituted derivatives thereof. Preferred anionic delocalized π-bonded groups are cyclopentadienyl, pentamethylcyclopentadienyl, tetramethylcyclopentadienyl, tetramethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, 1-indacenyl, 3-pyrrolidinoinden-1-yl, 3,4-(cyclopenta(1)phenanthren-1-yl, and tetrahydroindenyl.

More specifically this class of Group 4 metal complexes used according to the present invention includes “constrained geometry catalysts” corresponding to the formula:

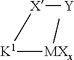

In the previous formula, M is titanium or zirconium, preferably titanium in the +2, +3, or +4 formal oxidation state; K¹ is a delocalized, π-bonded ligand group optionally substituted with from 1 to 5 R² groups, R² at each occurrence independently is selected from the group consisting of hydrogen, hydrocarbyl, silyl, germyl, cyano, halo and combinations thereof, said R² having up to 20 non-hydrogen atoms, or adjacent R² groups together form a divalent derivative (that is, a hydrocarbadiyl, siladiyl or germadiyl group) thereby forming a fused ring system, each X is a halo, hydrocarbyl, heterohydrocarbyl, hydrocarbyloxy or silyl group, said group having up to 20 non-hydrogen atoms, or two X groups together form a neutral C5-30 conjugated diene or a divalent derivative thereof, x is 1 or 2; Y is —O—, —S—, —NR′—, —PR′—; and X′ is SiR′₂, CR′₂, SiR′₂SiR′₂, CR′₂CR′₂, CR′═CR′, CR′₂SiR′₂, or GeR′₂, wherein R′ independently at each occurrence is hydrogen or a group selected from silyl, hydrocarbyl, hydrocarbyloxy and combinations thereof, said R′ having up to 30 carbon or silicon atoms.

Specific examples of the foregoing constrained geometry metal complexes include compounds corresponding to the formula:

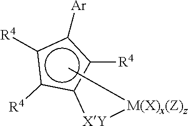

In the previous formula, Ar is an aryl group of from 6 to 30 atoms not counting hydrogen; R⁴ independently at each occurrence is hydrogen, Ar, or a group other than Ar selected from hydrocarbyl, trihydrocarbylsilyl, trihydrocarbylgermyl, halide, hydrocarbyloxy, trihydrocarbylsiloxy, bis(trihydrocarbylsilyl)amino, di(hydrocarbyl)amino, hydrocarbadiylamino, hydrocarbylimino, di(hydrocarbyl)phosphino, hydrocarbadiylphosphino, hydrocarbylsulfido, halo-substituted hydrocarbyl, hydrocarbyloxy-substituted hydrocarbyl, trihydrocarbylsilyl-substituted hydrocarbyl, trihydrocarbylsiloxy-substituted hydrocarbyl, bis(trihydrocarbylsilyl)amino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylenephosphino-substituted hydrocarbyl, or hydrocarbylsulfido-substituted hydrocarbyl, said R group having up to 40 atoms not counting hydrogen atoms, and optionally two adjacent R⁴ groups may be joined together forming a polycyclic fused ring group; M is titanium; X′ is SiR⁶₂, CR⁶₂, SiR⁶₂SiR⁶₂, CR⁶₂CR⁶₂, CR⁶═CR⁶, CR⁶₂SiR⁶₂, BR⁶, BR⁶L″, or GeR⁶₂; Y is —O—, —S—, —NR⁵—, —PR⁵—; —NR⁵₂, or —PR⁵₂; R⁵, independently at each occurrence is hydrocarbyl, trihydrocarbylsilyl, or trihydrocarbylsilylhydrocarbyl, said R⁵ having up to 20 atoms other than hydrogen, and optionally two R⁵ groups or R⁵ together with Y or Z form a ring system; R⁶, independently at each occurrence, is hydrogen, or a member selected from hydrocarbyl, hydrocarbyloxy, silyl, halogenated alkyl, halogenated aryl, —NR⁵₂, and combinations thereof, said R⁶ having up to 20 non-hydrogen atoms, and optionally, two R⁶ groups or R⁶ together with Z forms a ring system; Z is a neutral diene or a monodentate or polydentate Lewis base optionally bonded to R⁵, R⁶, or X; X is hydrogen, a monovalent anionic ligand group having up to 60 atoms not counting hydrogen, or two X groups are joined together thereby forming a divalent ligand group; x is 1 or 2; and z is 0, 1 or 2.

Additional examples of suitable metal complexes herein are polycyclic complexes corresponding to the formula:

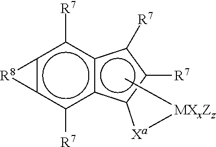

In the previous formula, M is titanium in the +2, +3 or +4 formal oxidation state; R⁷ independently at each occurrence is hydride, hydrocarbyl, silyl, germyl, halide, hydrocarbyloxy, hydrocarbylsiloxy, hydrocarbylsilylamino, di(hydrocarbyl)amino, hydrocarbyleneamino, di(hydrocarbyl)phosphino, hydrocarbylene-phosphino, hydrocarbylsulfido, halo-substituted hydrocarbyl, hydrocarbyloxy-substituted hydrocarbyl, silyl-substituted hydrocarbyl, hydrocarbylsiloxy-substituted hydrocarbyl, hydrocarbylsilylamino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylene-phosphino-substituted hydrocarbyl, or hydrocarbylsulfido-substituted hydrocarbyl, said R⁷ group having up to 40 atoms not counting hydrogen, and optionally two or more of the foregoing groups may together form a divalent derivative; R⁸ is a divalent hydrocarbylene- or substituted hydrocarbylene group forming a fused system with the remainder of the metal complex, said R⁸ containing from 1 to 30 atoms not counting hydrogen; X^{a} is a divalent moiety, or a moiety comprising one R-bond and a neutral two electron pair able to form a coordinate-covalent bond to M, said X^{a} comprising boron, or a member of Group 14 of the Periodic Table of the Elements, and also comprising nitrogen, phosphorus, sulfur or oxygen; X is a monovalent anionic ligand group having up to 60 atoms exclusive of the class of ligands that are cyclic, delocalized, π-bound ligand groups and optionally two X groups together form a divalent ligand group; Z independently at each occurrence is a neutral ligating compound having up to 20 atoms; x is 0, 1 or 2; and z is zero or 1.

Additional examples of metal complexes that are usefully employed as catalysts are complexes of polyvalent Lewis bases, such as compounds corresponding to the formula:

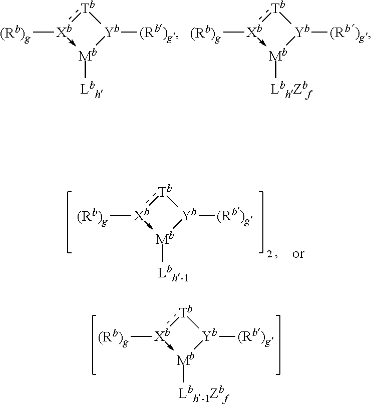

In the previous formulas, T^{b} is a bridging group, preferably containing 2 or more atoms other than hydrogen, X^{b} and Y^{b} are each independently selected from the group consisting of nitrogen, sulfur, oxygen and phosphorus; more preferably both X^{b} and Y^{b} are nitrogen, R^{b} and R^{b′} independently each occurrence are hydrogen or C₁₋₅₀ hydrocarbyl groups optionally containing one or more heteroatoms or inertly substituted derivative thereof. Non-limiting examples of suitable R^{b} and R^{b′} groups include alkyl, alkenyl, aryl, aralkyl, (poly)alkylaryl and cycloalkyl groups, as well as nitrogen, phosphorus, oxygen and halogen substituted derivatives thereof. Specific examples of suitable R^{b} and R^{b′} groups include methyl, ethyl, isopropyl, octyl, phenyl, 2,6-dimethylphenyl, 2,6-di(isopropyl)phenyl, 2,4,6-trimethylphenyl, pentafluorophenyl, 3,5-trifluoromethylphenyl, and benzyl; g and g′ are each independently 0 or 1; M^{b} is a metallic element selected from Groups 3 to 15, or the Lanthanide series of the Periodic Table of the Elements. Preferably, M^{b} is a Group 3-13 metal, more preferably M^{b} is a Group 4-10 metal; L^{b} is a monovalent, divalent, or trivalent anionic ligand containing from 1 to 50 atoms, not counting hydrogen. Examples of suitable L^{b} groups include halide; hydride; hydrocarbyl, hydrocarbyloxy; di(hydrocarbyl)amido, hydrocarbyleneamido, di(hydrocarbyl)phosphido; hydrocarbylsulfido; hydrocarbyloxy, tri(hydrocarbylsilyl)alkyl; and carboxylates. More preferred L^{b} groups are C1-20 alkyl, C₇₋₂₀ aralkyl, and chloride; h and h′ are each independently an integer from 1 to 6, preferably from 1 to 4, more preferably from 1 to 3, and j is 1 or 2, with the value h×j selected to provide charge balance; Z^{b} is a neutral ligand group coordinated to M^{b}, and containing up to 50 atoms not counting hydrogen. Preferred Z^{b} groups include aliphatic and aromatic amines, phosphines, and ethers, alkenes, alkadienes, and inertly substituted derivatives thereof. Suitable inert substituents include halogen, alkoxy, aryloxy, alkoxycarbonyl, aryloxycarbonyl, di(hydrocarbyl)amine, tri(hydrocarbyl)silyl, and nitrile groups. Preferred Z^{b} groups include triphenylphosphine, tetrahydrofuran, pyridine, and 1,4-diphenylbutadiene; f is an integer from 1 to 3; two or three of T^{b}, R^{b} and R^{b′} may be joined together to form a single or multiple ring structure; h is an integer from 1 to 6, preferably from 1 to 4, more preferably from 1 to 3;

In one embodiment, it is preferred that R^{b} have relatively low steric hindrance with respect to X^{b}. In this embodiment, most preferred R^{b} groups are straight chain alkyl groups, straight chain alkenyl groups, branched chain alkyl groups wherein the closest branching point is at least 3 atoms removed from X^{b}, and halo, dihydrocarbylamino, alkoxy or trihydrocarbylsilyl substituted derivatives thereof. Highly preferred R^{b} groups in this embodiment are C1-8 straight chain alkyl groups.

At the same time, in this embodiment R^{b′} preferably has relatively high steric hindrance with respect to Y^{b}. Non-limiting examples of suitable R^{b′} groups for this embodiment include alkyl or alkenyl groups containing one or more secondary or tertiary carbon centers, cycloalkyl, aryl, alkaryl, aliphatic or aromatic heterocyclic groups, organic or inorganic oligomeric, polymeric or cyclic groups, and halo, dihydrocarbylamino, alkoxy or trihydrocarbylsilyl substituted derivatives thereof. Preferred R^{b′} groups in this embodiment contain from 3 to 40, more preferably from 3 to 30, and most preferably from 4 to 20 atoms not counting hydrogen and are branched or cyclic. Examples of preferred T^{b} groups are structures corresponding to the following formulas:

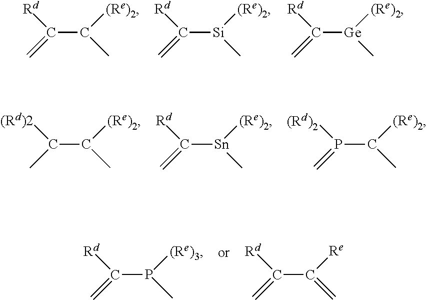

wherein

Each R^{d} is C1-10 hydrocarbyl group, preferably methyl, ethyl, n-propyl, i-propyl, t-butyl, phenyl, 2,6-dimethylphenyl, benzyl, or tolyl. Each R^{e} is C1-10 hydrocarbyl, preferably methyl, ethyl, n-propyl, i-propyl, t-butyl, phenyl, 2,6-dimethylphenyl, benzyl, or tolyl. In addition, two or more R^{d} or R^{e} groups, or mixtures of Rd and Re groups may together form a divalent or polyvalent derivative of a hydrocarbyl group, such as, 1,4-butylene, 1,5-pentylene, or a cyclic ring, or a multicyclic fused ring, polyvalent hydrocarbyl- or heterohydrocarbyl-group, such as naphthalene-1,8-diyl.

Suitable examples of the foregoing polyvalent Lewis base complexes include:

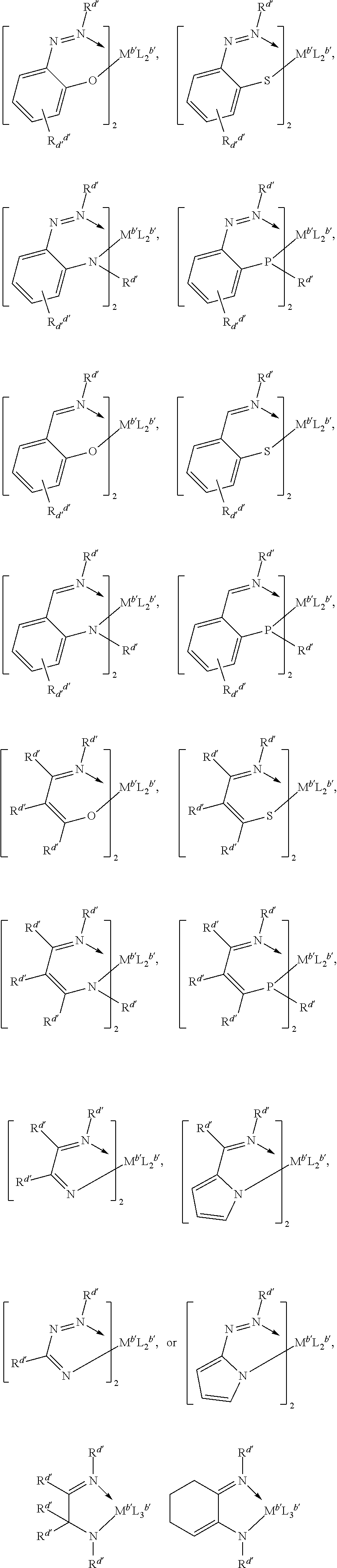

In the previous formula, R^{d′} at each occurrence is independently selected from the group consisting of hydrogen and C1-50 hydrocarbyl groups optionally containing one or more heteroatoms, or inertly substituted derivative thereof, or further optionally, two adjacent R^{d′} groups may together form a divalent bridging group; d′ is 4; M^{b′} is a Group 4 metal, preferably titanium or hafnium, or a Group 10 metal, preferably Ni or Pd; L^{b′} is a monovalent ligand of up to 50 atoms not counting hydrogen, preferably halide or hydrocarbyl, or two L^{b′} groups together are a divalent or neutral ligand group, preferably a C₂₋₅₀ hydrocarbylene, hydrocarbadiyl or diene group.

The polyvalent Lewis base complexes for use in the present invention especially include Group 4 metal derivatives, especially hafnium derivatives of hydrocarbylamine substituted heteroaryl compounds corresponding to the formula:

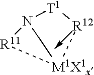

In the previous formula, R¹¹ is selected from alkyl, cycloalkyl, heteroalkyl, cycloheteroalkyl, aryl, and inertly substituted derivatives thereof containing from 1 to 30 atoms not counting hydrogen or a divalent derivative thereof; T¹ is a divalent bridging group of from 1 to 41 atoms other than hydrogen, preferably 1 to 20 atoms other than hydrogen, and most preferably a mono- or di-C1-20 hydrocarbyl substituted methylene or silane group; and R¹² is a C₅₋₂₀ heteroaryl group containing Lewis base functionality, especially a pyridin-2-yl- or substituted pyridin-2-yl group or a divalent derivative thereof; M¹ is a Group 4 metal, preferably hafnium; X¹ is an anionic, neutral or dianionic ligand group; x′ is a number from 0 to 5 indicating the number of such X¹ groups; and bonds, optional bonds and electron donative interactions are represented by lines, dotted lines and arrows respectively.

Suitable complexes are those wherein ligand formation results from hydrogen elimination from the amine group and optionally from the loss of one or more additional groups, especially from R¹². In addition, electron donation from the Lewis base functionality, preferably an electron pair, provides additional stability to the metal center. Suitable metal complexes correspond to the formula:

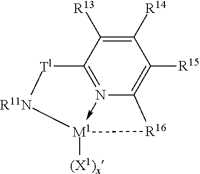

In the previous formula, M¹, X¹, x′, R¹¹ and T¹ are as previously defined, R¹³, R¹⁴, R¹⁵ and R¹⁶ are hydrogen, halo, or an alkyl, cycloalkyl, heteroalkyl, heterocycloalkyl, aryl, or silyl group of up to 20 atoms not counting hydrogen, or adjacent R¹³, R¹⁴, R¹⁵ or R¹⁶ groups may be joined together thereby forming fused ring derivatives, and bonds, optional bonds and electron pair donative interactions are represented by lines, dotted lines and arrows respectively.

Suitable examples of the foregoing metal complexes correspond to the formula:

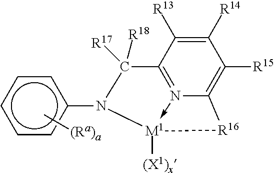

In the previous formula, M¹, X¹, and x′ are as previously defined, R¹³, R¹⁴, R¹⁵ and R¹⁶ are as previously defined, preferably R¹³, R¹⁴, and R¹⁵ are hydrogen, or C1-4 alkyl, and R¹⁶ is C₆₋₂₀ aryl, most preferably naphthalenyl; Ra independently at each occurrence is C₁₋₄ alkyl, and a is 1-5, most preferably Ra in two ortho-positions to the nitrogen is isopropyl or t-butyl; R¹⁷ and R¹⁸ independently at each occurrence are hydrogen, halogen, or a C₁₋₂₀ alkyl or aryl group, most preferably one of R¹⁷ and R¹⁸ is hydrogen and the other is a C6-20 aryl group, especially 2-isopropyl, phenyl or a fused polycyclic aryl group, most preferably an anthracenyl group, and

Exemplary metal complexes for use herein as catalysts correspond to the formula:

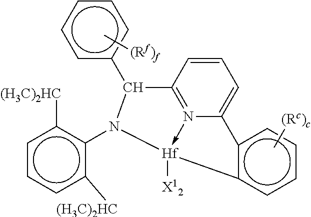

In the formula, X¹ at each occurrence is halide, N,N-dimethylamido, or C₁₋₄ alkyl, and preferably at each occurrence X¹ is methyl; R^{f} independently at each occurrence is hydrogen, halogen, C1-20 alkyl, or C6-20 aryl, or two adjacent R^{f} groups are joined together thereby forming a ring, and f is 1-5; and R^{c} independently at each occurrence is hydrogen, halogen, C₁₋₂₀ alkyl, or C₆₋₂₀ aryl, or two adjacent R^{c} groups are joined together thereby forming a ring, and c is 1-5.

Suitable examples of metal complexes for use as catalysts include the following formulas:

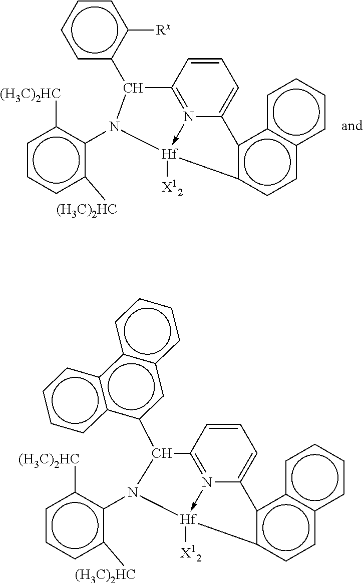

In the previous formula, R^{x} is C1-4 alkyl or cycloalkyl, preferably methyl, isopropyl, t-butyl or cyclohexyl; and X¹ at each occurrence is halide, N,N-dimethylamido, or C1-4 alkyl, preferably methyl.

Examples of metal complexes usefully employed as catalysts according to the present invention include:
[N-(2,6-di(1-methylethyl)phenyl)amido)(o-tolyl)(α-naphthalen-2-diyl(6-pyridin-2-diyl)methane)]hafnium dimethyl;
[N-(2,6-di(1-methylethyl)phenyl)amido)(o-tolyl)(α-naphthalen-2-diyl(6-pyridin-2-diyl)methane)]hafnium di(N,N-dimethylamido);
[N-(2,6-di(1-methylethyl)phenyl)amido)(o-tolyl)(α-naphthalen-2-diyl(6-pyridin-2-diyl)methane)]hafnium dichloride;
[N-(2,6-di(1-methylethyl)phenyl)amido)(2-isopropylphenyl)(α-naphthalen-2-diyl(6-pyridin-2-diyl)methane)]hafnium dimethyl;
[N-(2,6-di(1-methylethyl)phenyl)amido)(2-isopropylphenyl)(α-naphthalen-2-diyl(6-pyridin-2-diyl)methane)]hafnium di(N,N-dimethylamido);
[N-(2,6-di(1-methylethyl)phenyl)amido)(2-isopropylphenyl)(α-naphthalen-2-diyl(6-pyridin-2-diyl)methane)]hafnium dichloride;
[N-(2,6-di(1-methylethyl)phenyl)amido)(phenanthren-5-yl)(α-naphthalen-2-diyl(6-pyridin-2-diyl)methane)]hafnium dimethyl;
[N-(2,6-di(1-methylethyl)phenyl)amido)(phenanthren-5-yl)(α-naphthalen-2-diyl(6-pyridin-2-diyl)methane)]hafnium di(N,N-dimethylamido); and
[N-(2,6-di(1-methylethyl)phenyl)amido)(phenanthren-5-yl)(α-naphthalen-2-diyl(6-pyridin-2-diyl)methane)]hafnium dichloride.

Under the reaction conditions used to prepare the metal complexes used in the present disclosure, the hydrogen of the 2-position of the α-naphthalene group substituted at the 6-position of the pyridin-2-yl group is subject to elimination, thereby uniquely forming metal complexes wherein the metal is covalently bonded to both the resulting amide group and to the 2-position of the α-naphthalenyl group, as well as stabilized by coordination to the pyridinyl nitrogen atom through the electron pair of the nitrogen atom.

Further procatalysts that are suitable include imidazole-amine compounds corresponding to those disclosed in WO 2007/130307A2, WO 2007/130306A2, and U.S. Patent Application Publication No. 20090306318A1, which are incorporated herein by reference in their entirety. Such imidazole-amine compounds include those corresponding to the formula:

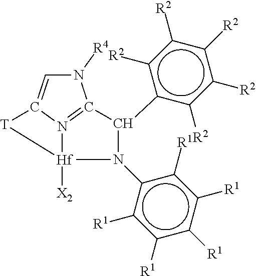

In the imidazole-amine compounds, X independently each occurrence is an anionic ligand, or two X groups together form a dianionic ligand group, or a neutral diene; T is a cycloaliphatic or aromatic group containing one or more rings; R¹ independently each occurrence is hydrogen, halogen, or a univalent, polyatomic anionic ligand, or two or more R¹ groups are joined together thereby forming a polyvalent fused ring system; R² independently each occurrence is hydrogen, halogen, or a univalent, polyatomic anionic ligand, or two or more R² groups are joined together thereby forming a polyvalent fused ring system; and R⁴ is hydrogen, alkyl, aryl, aralkyl, trihydrocarbylsilyl, or trihydrocarbylsilylmethyl of from 1 to 20 carbons.

Further examples of such imidazole-amine compounds include but are not limited to the following:

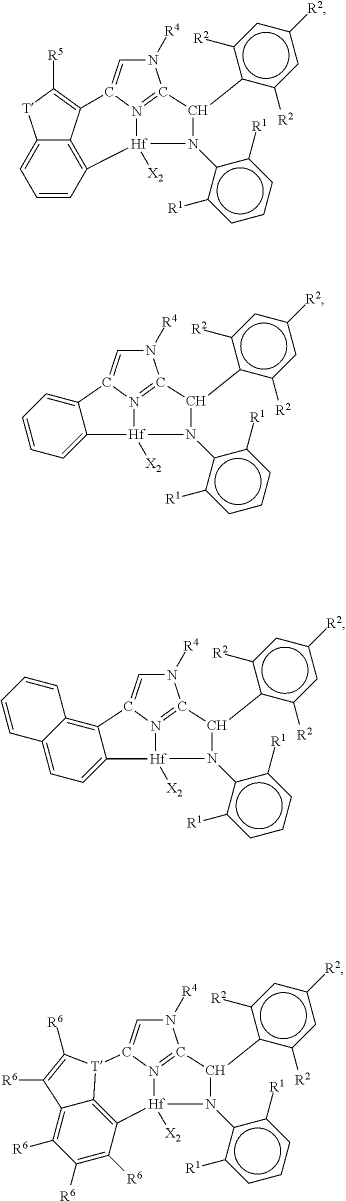

In the imidazole-amine compounds, R¹ independently each occurrence is a C₃₋₁₂ alkyl group wherein the carbon attached to the phenyl ring is secondary or tertiary substituted; R² independently each occurrence is hydrogen or a C₁₋₂ alkyl group; R⁴ is methyl or isopropyl; R⁵ is hydrogen or C₁₋₆ alkyl; R⁶ is hydrogen, C₁₋₆ alkyl or cycloalkyl, or two adjacent R⁶ groups together form a fused aromatic ring; T′ is oxygen, sulfur, or a C₁₋₂₀ hydrocarbyl-substituted nitrogen or phosphorus group; T″ is nitrogen or phosphorus; and X is methyl or benzyl.

The catalyst systems of this disclosure may include co-catalysts or activators in addition to the ionic metallic activator complex having the anion of formula (I) and a countercation. Such additional co-catalysts may include, for example, tri(hydrocarbyl)aluminum compounds having from 1 to 10 carbons in each hydrocarbyl group, an oligomeric or polymeric alumoxane compound, di(hydrocarbyl)(hydrocarbyloxy)aluminums compound having from 1 to 20 carbons in each hydrocarbyl or hydrocarbyloxy group, or mixtures of the foregoing compounds. These aluminum compounds are usefully employed for their beneficial ability to scavenge impurities such as oxygen, water, and aldehydes from the polymerization mixture.

The di(hydrocarbyl)(hydrocarbyloxy)aluminum compounds that may be used in conjunction with the activators described in this disclosure correspond to the formula T¹₂AlOT² or T¹₁Al(OT²)₂ wherein T¹ is a secondary or tertiary (C₃-C₆)alkyl, such as isopropyl, isobutyl or tert-butyl; and T² is a alkyl substituted (C₆-C₃₀)aryl radical or aryl substituted (C₁-C₃₀)alkyl radical, such as 2,6-di(tert-butyl)-4-methylphenyl, 2,6-di(tert-butyl)-4-methylphenyl, 2,6-di(tert-butyl)-4-methyltolyl, or 4-(3′,5′-di-tert-butyltolyl)-2,6-di-tert-butylphenyl.

Additional examples of aluminum compounds include [C₆]trialkyl aluminum compounds, especially those wherein the alkyl groups are ethyl, propyl, isopropyl, n-butyl, isobutyl, pentyl, neopentyl, or isopentyl, dialkyl(aryloxy)aluminum compounds containing from 1-6 carbons in the alkyl group and from 6 to 18 carbons in the aryl group (especially (3,5-di(t-butyl)-4-methylphenoxy)diisobutylaluminum), methylalumoxane, modified methylalumoxane and diisobutylalumoxane.

In the catalyst systems according to embodiments of this disclosure, the molar ratio of the ionic metallic activator complex to Group IV metal-ligand complex may be from 1:10,000 to 1000:1, such as, for example, from 1:5000 to 100:1, from 1:100 to 100:1 from 1:10 to 10:1, from 1:5 to 1:1, or from 1.25:1 to 1:1. The catalyst systems may include combinations of one or more ionic metallic activator complexes described in this disclosure.

### Polyolefins

The catalytic systems described in the preceding paragraphs are utilized in the polymerization of olefins, primarily ethylene and propylene. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, 4-methyl-1-pentene, 5-ethylidene-2-norbornene, and 5-vinyl-2-norbornene. For example, the one or more α-olefin co-monomers may be selected from the group consisting of propylene, 1-butene, 1-hexene, and 1-octene; or in the alternative, from the group consisting of 1-hexene and 1-octene.

Ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mol %” are disclosed herein as separate embodiments; for example, the ethylene-based polymers, homopolymers and/or interpolymers (including copolymers) of ethylene and optionally one or more co-monomers such as α-olefins may comprise at least 60 mol % monomer units derived from ethylene; at least 70 mol % monomer units derived from ethylene; at least 80 mol % monomer units derived from ethylene; or from 50 to 100 mol % monomer units derived from ethylene; or from 80 to 100 mol % units derived from ethylene.

In some embodiments, the ethylene-based polymers may comprise at least 90 mole percent units derived from ethylene. All individual values and subranges from at least 90 mole percent are included herein and disclosed herein as separate embodiments. For example, the ethylene-based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments of the ethylene-based polymer, the ethylene-based polymers may comprise an amount of (C₃-C₂₀)α-olefin. The amount of (C₃-C₂₀)α-olefin is less than 50 mol %. In some embodiments, the ethylene-based polymer may include at least 0.5 mol % to 25 mol % of (C₃-C₂₀)α-olefin; and in further embodiments, the ethylene-based polymer may include at least 5 mol % to 10 mol %. In some embodiments, the additional α-olefin is 1-octene.

Any conventional polymerization process, in combination with a catalyst system according to embodiments of this disclosure may be used to produce the ethylene-based polymers. Such conventional polymerization processes include, but are not limited to, solution polymerization processes, gas-phase polymerization processes, slurry-phase polymerization processes, and combinations thereof using one or more conventional reactors such as loop reactors, isothermal reactors, fluidized-bed gas-phase reactors, stirred-tank reactors, batch reactors in parallel, series, or any combinations thereof, for example.

In one embodiment, ethylene-based polymer may be produced via solution polymerization in a dual reactor system, for example a dual-loop reactor system, wherein ethylene and optionally one or more α-olefins are polymerized in the presence of the catalyst system, as described herein, and optionally one or more co-catalysts. In another embodiment, the ethylene-based polymer may be produced via solution polymerization in a dual reactor system, for example a dual-loop reactor system, wherein ethylene and optionally one or more α-olefins are polymerized in the presence of the catalyst system in this disclosure, and as described herein, and optionally one or more other catalysts. The catalyst system, as described herein, can be used in the first reactor, or second reactor, optionally in combination with one or more other catalysts. In one embodiment, the ethylene-based polymer may be produced via solution polymerization in a dual reactor system, for example a dual-loop reactor system, wherein ethylene and optionally one or more α-olefins are polymerized in the presence of the catalyst system, as described herein, in both reactors.

In another embodiment, the ethylene-based polymer may be produced via solution polymerization in a single reactor system, for example a single-loop reactor system, in which ethylene and optionally one or more α-olefins are polymerized in the presence of the catalyst system, as described within this disclosure.

The polymer process may further include incorporating one or more additives. Such additives include, but are not limited to, antistatic agents, color enhancers, dyes, lubricants, pigments, primary antioxidants, secondary antioxidants, processing aids, UV stabilizers, and combinations thereof. The ethylene-based polymers may contain any amounts of additives. The ethylene-based polymers may comprise from about 0 to about 10 percent by weight of the total amount of such additives, based on the weight of the ethylene-based polymers and the one or more additives. The ethylene-based polymers may further comprise fillers, which may include, but are not limited to, organic or inorganic fillers. The ethylene-based polymers may contain from about 0 to about 20 weight percent fillers such as, for example, calcium carbonate, talc, or Mg(OH)₂, based on the combined weight of the ethylene-based polymers and all additives or fillers. The ethylene-based polymers may further be blended with one or more polymers to form a blend.

In some embodiments, a polymerization process for producing an ethylene-based polymer may include polymerizing ethylene and at least one additional α-olefin in the presence of a catalyst system, wherein the catalyst system incorporates at least one metal-ligand complex and an ionic metallic activator complex and, optionally a scavenger. The polymer resulting from such a catalyst system that incorporates the metal-ligand complex and the ionic metallic activator complex may have a density according to ASTM D792 (incorporated herein by reference in its entirety) from 0.850 g/cm³ to 0.950 g/cm³, from 0.870 g/cm³ to 0.920 g/cm³, from 0.870 g/cm³ to 0.910 g/cm³, or from 0.870 g/cm³ to 0.900 g/cm³, for example.

In another embodiment, the polymer resulting from the catalyst system that includes the metal-ligand complex and an ionic metallic activator complex has a melt flow ratio (I₁₀/I₂) from 5 to 15, in which melt index I₂ is measured according to ASTM D1238 (incorporated herein by reference in its entirety) at 190° C. and 2.16 kg load, and melt index I₁₀ is measured according to ASTM D1238 at 190° C. and 10 kg load. In other embodiments the melt flow ratio (I₁₀/I₂) is from 5 to 10, and in others, the melt flow ratio is from 5 to 9.

In some embodiments, the polymer resulting from the catalyst system that includes the metal-ligand complex and the ionic metallic activator complex has a molecular-weight distribution (MWD) from 1 to 25, where MWD is defined as M_{w}/Mₙ with M_{w} being a weight-average molecular weight and Mₙ being a number-average molecular weight. In other embodiments, the polymers resulting from the catalyst system have a MWD from 1 to 6. Another embodiment includes a MWD from 1 to 3; and other embodiments include MWD from 1.5 to 2.5.

### Batch Reactor Procedure

A 2 L Parr reactor was used for all polymerization experiments. The reactor was heated via an electrical heating mantle and was cooled via an internal serpentine cooling coil containing water. Both the reactor and the heating/cooling system were controlled and monitored by a Camile TG process computer. All chemicals used for polymerization or catalyst makeup were run through purification columns. 1-octene, toluene, and Isopar-E (a mixed alkanes solvent available from ExxonMobil, Inc.) were passed through 2 columns, the first containing A2 alumina, and the second containing Q5 reactant (available from Engelhard Chemicals Inc.). Ethylene gas was passed through 2 columns, the first containing A204 alumina and activated 4 Å molecular sieves, the second containing Q5 reactant. Hydrogen gas was passed through Q5 reactant and A2 alumina. Nitrogen gas was passed through a single column containing A204 alumna, activated 4 Å molecular sieves and Q5 reactant. Catalyst and cocatalyst (also called the activator) solutions were handled in a nitrogen-filled glovebox.

The load column was filled with Isopar-E to the load setpoints by use of an Ashcroft differential pressure cell, and the material was transferred into the reactor. 1-octene was measured by syringe and added via the shot tank due to low amount used. Once complete, the reactor immediately begins heating toward the reaction setpoint. Scavenger (MMAO-3A, 20 μmol) solution was added to the reactor via the shot tank once 25 degrees prior to the setpoint. Next, chain transfer agent (typically tri-n-octylaluminum) was added to the reactor via the shot tank. At 10 degrees prior to reaching the setpoint, ethylene was added to the specified pressure as monitored via a micro-motion flow meter. Finally, at this same time, dilute toluene solutions of catalyst and cocatalyst (as specified) were mixed, transferred to the shot tank, and added to the reactor to begin the polymerization reaction. The polymerization conditions were typically maintained with supplemental ethylene added on demand to maintain the specified pressure until an ethylene uptake of 20 g was achieved. Exothermic heat was continuously removed from the reaction vessel via the internal cooling coil. After the desired ethylene uptake was reached, the reactor was heated to 200° C., a process which required approximately 20 min. Once at temperature, the reactor was held at 200° C. for an additional 20 min to allow for elimination of polymeryl chains from in situ generated polymeryl aluminum to yield a solution of vinyl-terminated ethylene/1-octene copolymer. The resulting solution was removed from the reactor without the addition of the typical antioxidant package (Irganox 1010 and Irgafos 168). Polymers were recovered by evaporating in a hood overnight and then drying for about 12 h in a temperature-ramped vacuum oven with a final set point of 140° C.

Between polymerization runs, at least one wash cycle was conducted in which Isopar-E (850 g) was added and the reactor was heated to a setpoint between 160° C. and 190° C. The reactor was then emptied of the heated solvent immediately before beginning a new polymerization run.

### EXAMPLES

Reaction Sequences A to H are illustrative of the synthetic procedure for the polymerization process as shown in Scheme 1. In each reaction sequence, the vinyl-terminated polyolefin is different. Each vinyl-terminated polyolefin varies based on molecular weight and the units derived from the comonomer incorporation. One or more features of the present disclosure are illustrated in view of the examples as follows:

In Reaction Sequence A to C, the vinyl-terminated polyolefin had a low molecular weight. In Reaction Sequence D, the vinyl-terminated polyolefin had a very low molecular weight. In Reaction Sequence E to G, the vinyl-terminated polyolefin had a high molecular weight. In Reaction Sequence H, the thiol compound was 2-(BOC-amino)ethanethiol.

### Example 1—Synthesis of Vinyl-Terminated polyolefins (Vinyl Terminated polyolefin 1, 2, 3, 4, 5, 6, and 7) Via trialkyl aluminum Chain-Transfer Agents

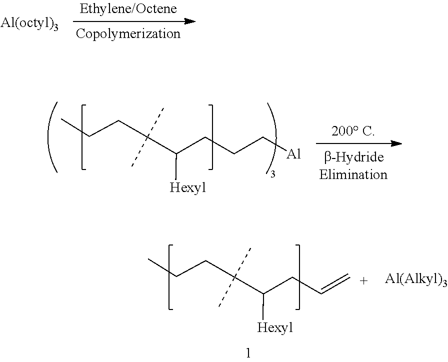

To synthesize the vinyl-terminated polyolefin, ethylene and optionally octene were polymerized in the presence of Al(octyl)₃ and Procatalyst 1 or Procatalyst 2. The alkyl aluminum functioned as a chain-transfer agent that resulted in the formation of polymeryl aluminum species. After the olefin polymerization stage, the reaction mixture was heated in the presence of excess ethylene and octene to obtain predominantly vinyl-terminated polymer and trialkyl aluminum at equilibrium.

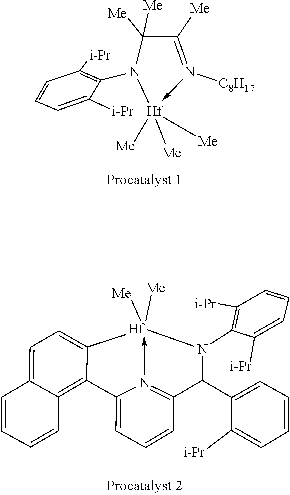

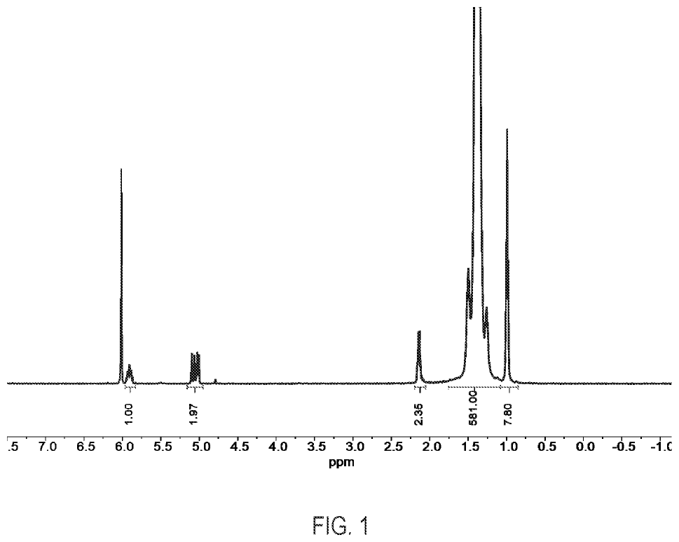

The results summarized in Table 1 provide the molecular weight of the produced vinyl-terminated polyolefin expressed as M_{n, effective} as determined by ¹H NMR (see FIG. 1). To obtain the M_{n effective}, the number of vinyl groups was normalized to 1, and the molecular weight contributions from the vinyl group (27 g/mol), aliphatic/polyolefin protons (2H=14 g/mol), and any other identifiable functional groups was totaled. It was assumed that all vinyl groups were attached to a polymer and all polymers have exactly 1 vinyl group. Using M_{n, effective} allowed for a single value to express the molecular weight, while giving the correct concentration of functional groups for the purposes of reaction stoichiometry. In Table 1, there are only significant discrepancies between M_{n,effective} and the GPC Mₙ for the higher MW polymers, where chain-end functionality is lower.

TABLE 1
End-functional polyolefins synthesized in the batch reactor
and used in synthesis of diblock copolymers.

| Vinyl- | | | | | | End- | | |
|---|---|---|---|---|---|---|---|---|
| terminated | | Mₙ | Ð | Tₘ | M_{n, effective}^{a} | Functional | | |
| polyolefin | Procat. | (GPC) | (GPC) | (DSC) | (¹H NMR) | Chains^{b} | Vinyl^{c} | Octene |
| — | — | [kDa] | — | [° C.] | [kDa] | [%] | [%] | [mol %] |
| 1 | Procat. 1 | 1.3 | 1.37 | 120 | 1.7 | 94.0 | 93.5 | — |
| 2 | Procat. 1 | 4.0 | 1.46 | 124 | 4.2 | 91.1 | 93.6 | 0.77 |
| 3 | Procat. 1 | 7.5 | 1.47 | 124 | 7.5 | 87.8 | 92.8 | 0.85 |
| 4 | Procat. 1 | 7.1 | 1.61 | 123 | 7.2 | 88.2 | 92.8 | 0.93 |
| 5 | Procat. 1 | 1.2 | 1.31 | 117 | 1.5 | 95.0 | 91.7 | — |
| 6 | Procat. 2 | 18.6 | 3.66 | 124 | 25.8 | 80 ± 8 | 92.6 | 0.57 |
| 7 | Procat. 2 | 17.6 | 3.47 | 122 | 26.6 | 71 ± 11 | 92.3 | 0.92 |

^{a}Defined as the Mₙ of the polymer if all chains were terminated with exactly 1 vinyl group as determined by ¹H NMR (see text for discussion).
^{b}The percent of chains that have one saturated (methyl) end-group and one unsaturated (olefinic) end-group.
^{c}Percent of unsaturated chain-ends which are vinyl.

Reaction Sequence A

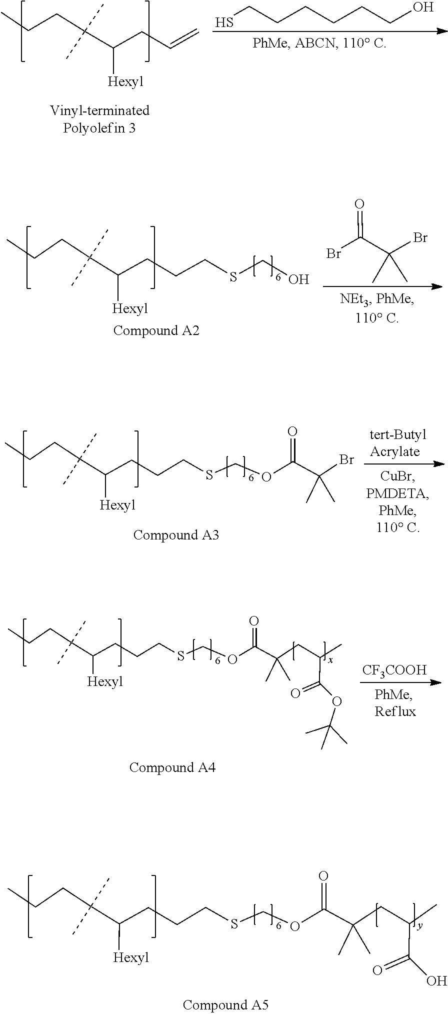

### Synthesis of Low MW hydroxyl-terminated polyolefin (Compound A2)

In a glovebox: Vinyl-terminated polyolefin 3 (Mₙ=7.5 kDa, 15.0 g, 2.0 mmol) was dissolved in 33 mL of toluene in a vented glass jar. 6-Mercaptohexanol (1.36 mL, 10.0 mmol, 5 equiv.) was added in one portion, followed by ABCN (248 mg, 1.0 mmol, 0.5 equiv.) in 2 mL of toluene. Reaction was stirred for 4 hr. at 110° C., then the reaction was removed from the glovebox. The product was precipitated into 500 mL of MeOH, filtered, and washed with an additional portion of MeOH. The product was then dried under a stream of N₂ overnight at 70° C. to give white polymer (14.4 g, 94% yield). ¹H NMR (500 MHz, 110° C., d1=70 s, TCE-d₂) δ 3.68 (q br, J=6.1 Hz, 2H, a), 2.55 (m br, 4H, c), 1.92-0.74 (br overlapping, 1125H, Polyolefin+other aliphatic+PE_{Me}).

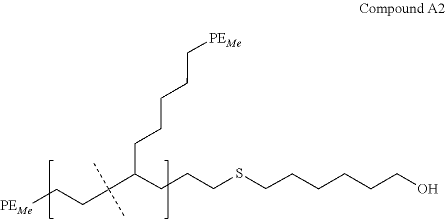

### Synthesis of Low MW Macroinitiator [Compound A3]

In a glove box: Hydroxyl-terminated polyethylene (Compound A2, Mₙ=8.0 kDa, 14.0 g, 1.75 mmol —OH) was dissolved in 48 mL of toluene in a jar at reflux. Triethylamine (1.22 mL, 8.80 mmol, 5 equiv.) was added, followed by the dropwise addition of 2-bromo-2-methylpropionyl bromide (0.87 mL, 7.0 mmol, 4 equiv.) diluted with 2 mL of toluene. The reaction was allowed to reflux for 75 minutes, then removed from the glovebox, precipitated into 800 mL of MeOH, filtered, then triturated with an additional 600 mL of MeOH and filtered again. The product was dried under a stream of N₂ overnight at 70° C. to give tan polymer (13.7 g, 96% yield). ¹H NMR (500 MHz, 110° C., d1=70 s, TCE-d₂) δ 4.25 (t br, 2H, a), 2.58 (m, 4H, c), 2.01 (s, 6H, d), 1.78 (m, 2H, b), 1.67 (m, 4H, e), 1.92-0.74 (br overlapping, 1143H, Polyolefin+other aliphatic+PE_{Me}).

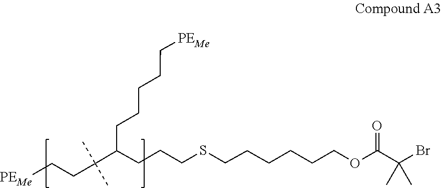

### Synthesis of Low MW polyolefin-b-poly(tBA) [Compound A4]

In a glove box, Compound A3, (Mₙ=8.4 kDa, 12.5 g, 1.5 mmol —Br) was dissolved in 25 mL of toluene at 110° C. Tert-butyl acrylate (5.5 mL, 38 mmol, 25 equiv.) was added and solution stirred until homogeneous. CuBr (214 mg, 1.50 mmol, 1 equiv.) and PMDETA (0.312 mL, 1.50 mmol, 1 equiv.) were added as a stock solution in benzonitrile (1.29 mL) and the reaction allowed to proceed for 1 hr. The reaction was terminated by removing from glovebox and exposing to air. The solution was diluted to 200 mL in hot toluene and washed with water, then 0.5 M EDTA solution until washings were nearly colorless, then precipitated twice into 800 mL MeOH and filtered. The product was dried under a stream of N₂ overnight at 70° C. to give tan polymer (14 g, 88% yield). ¹H NMR (500 MHz, 110° C., d1=70 s, TCE-d₂) δ 4.09 (t br, J=5.3, 2H, a), 2.55 (t br, J=7.4 Hz, 4H, c), 2.40-2.20 (br, 13H, f), 2.00-1.57 (br overlapping, 35H, d+g/g′), 1.51 (s br, 165H, e), 1.47-1.11 (br, 1193H, polyolefin+other aliphatic), 0.96 (t, J=6.7 Hz, 13H, PE_{Me}).

NMR indicated that the acrylate resonance was attached to a large molecule, with no evidence of small molecule acrylate. The diffusion coefficient decreased for PE compared to the parent polymer, consistent with an approximately 10 kDa molecular weight (polyolefin equivalent) polymer. The acrylate has a slightly bigger diffusion coefficient than PE, consistent with functionalization that is proportional to Mₙ, not M_{w} (while diffusion signal is proportional to mass).

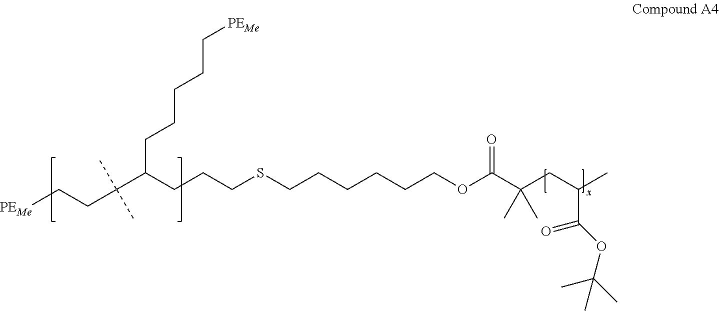

### Synthesis of Low MW polyolefin-b-poly(AA) [Compound A5]

In a glove box, Compound A4 (Mₙ=10.7 kDa, 13.5 g, 23.2 mmol tert-butyl groups) was dissolved in 50 mL of toluene at 110° C. Trifluoroacetic acid (8.16 mL, 106 mmol, 4.6 equiv.) was added and solution stirred at reflux for 10 minutes. The reaction mixture was then removed from the glovebox, precipitated into 600 mL MeOH, and filtered. The solid/gel was washed with an additional 400 mL of MeOH, and filtered again. The product was then dried under a stream of N₂ overnight at 70° C. to yield tan polymer (11.4 g, 90% yield). ¹H NMR (500 MHz, 110° C., d1=70 s, TCE-d₂:DMSO-d₆ 10:1 v/v) δ 9.75-8.60 (br, 13H, COOH), 1.55-0.40 (br overlapping, 1193H, polyolefin+other aliphatic+PE_{Me}).

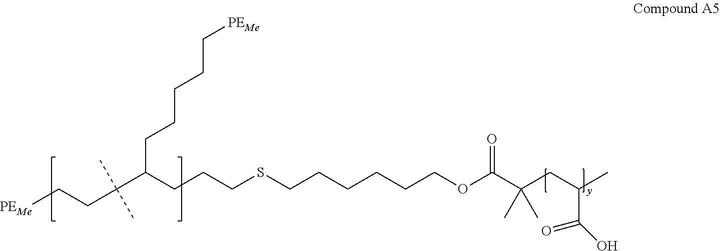

Reaction Sequence B

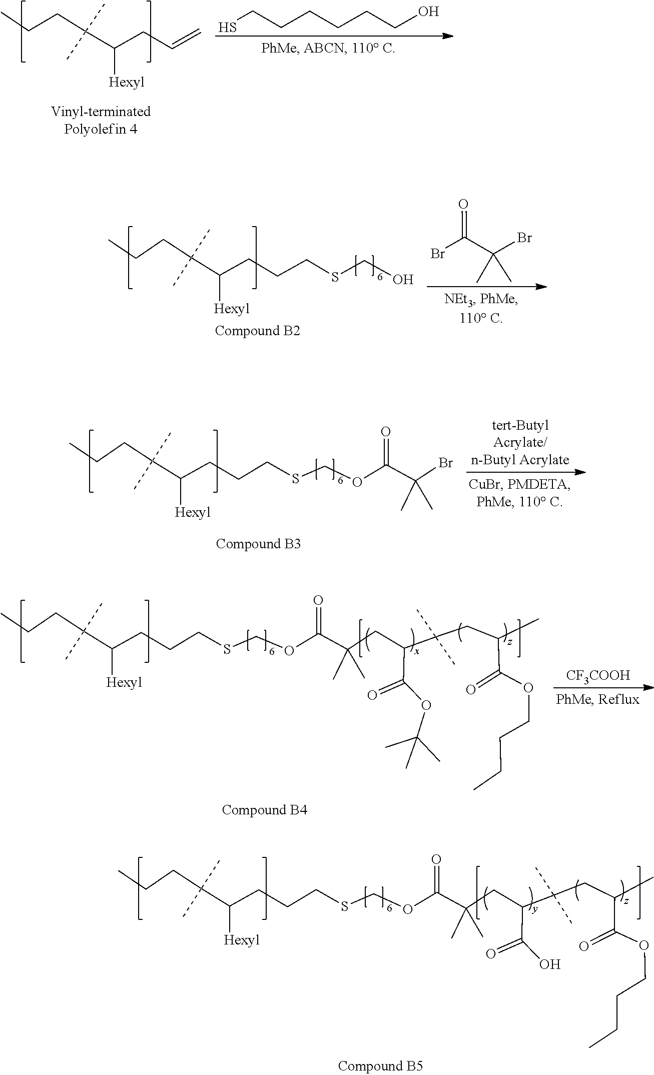

### Synthesis of Low MW hydroxyl-terminated polyolefin (Compound B2)

In a glovebox, Vinyl-terminated polyolefin 4 (Mₙ=7.2 kDa, 23.1 g, 3.2 mmol) was dissolved in 60 mL of toluene in a vented glass jar. 6-Mercaptohexanol (2.32 mL, 17.0 mmol, 5.3 equiv.) was added in one portion, followed by ABCN (414 mg, 1.7 mmol, 0.5 equiv.) in 2 mL of toluene. Reaction was stirred for 2 hr. at 110° C., then removed from the glovebox, precipitated into 800 mL of MeOH, filtered, and washed with an additional portion of MeOH. The product was then dried under a stream of N₂ overnight at 70° C. to give white polymer in quantitative yield. ¹H NMR (500 MHz, 110° C., d1=70 s, TCE-d₂) δ 3.68 (q br, J=6.1 Hz, 2H, a), 2.55 (m br, 4H, c), 1.92-0.74 (br overlapping, 1098H, Polyolefin+other aliphatic+PE_{Me}).

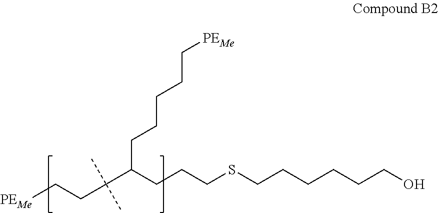

### Synthesis of Low MW Macroinitiator (Compound B3)

In a glove box, Compound B2 (Mₙ=7.7 kDa, 23.0 g, 3.0 mmol —OH) was dissolved in 90 mL of toluene in a jar at reflux. Triethylamine (2.06 mL, 14.9 mmol, 5 equiv.) was added, followed by the dropwise addition of 2-bromo-2-methylpropionyl bromide (1.47 mL, 11.9 mmol, 4 equiv.) diluted with 5 mL of toluene. The reaction was allowed to reflux for 75 minutes, then removed from the glovebox, precipitated into 800 mL of MeOH, filtered, then triturated with an additional 600 mL of MeOH and filtered again. The product was dried under a stream of N₂ overnight at 70° C. to give tan polymer in quantitative yield. ¹H NMR (500 MHz, 110° C., d1=70 s, TCE-d₂) δ 4.25 (t br, 2H, a), 2.58 (m, 4H, c), 2.01 (s, 6H, d), 1.78 (m, 2H, b), 1.67 (m, 5H, e), 1.92-0.74 (br overlapping, 1146H, Polyolefin+other aliphatic+PE_{Me}).

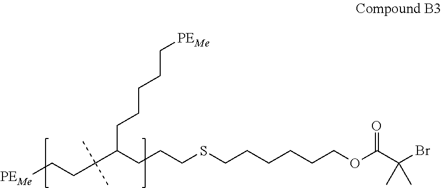

### Synthesis of Low MW polyolefin-b-poly(tBA)-r-poly(nBA) (Compound B4)

In a glove box, Compound B3 (Mₙ=8.0 kDa, 10.0 g, 1.21 mmol —Br) was dissolved in 28 mL of toluene at 110° C. Tert-butyl acrylate (4.42 mL, 30.2 mmol, 25 equiv.) and n-butyl acrylate (4.32 mL, 30.2 mmol, 25 equiv.) were added was added and solution stirred until homogeneous. CuBr (173 mg, 1.21 mmol, 1 equiv.) and PMDETA (209 mg, 1.21 mmol, 1 equiv.) were added as a stock solution in benzonitrile (1.04 mL) and the reaction allowed to proceed for 1 hr. The reaction was terminated by removing from glovebox and exposing to air. The solution was diluted to 200 mL in hot toluene, washed with water, then washed with 0.5 M EDTA solution until washings were nearly colorless, then precipitated twice into 800 mL MeOH and filtered. The product was dried under a stream of N₂ overnight at 70° C. to give tan polymer (12.6 g, 82% yield). ¹H NMR (500 MHz, 110° C., d1=70 s, TCE-d₂) δ 4.10 (br, 32H, a+h), 2.50-2.40 (br, 17H, i+c), 2.40-2.20 (br, 17H, f), 2.00-1.57 (br overlapping, 88H, d+g/g′+j/j′+k), 1.54-1.43 (br, 194H, e+l), 1.47-1.11 (br, 1118H, Polyolefin+other aliphatic), 1.04-0.92 (t, J=6.7 Hz, 59H, PE_{Me}+nBu_{Me}).

NMR indicated that the acrylate monomers attached to a large molecule, with no evidence of small molecule acrylate.

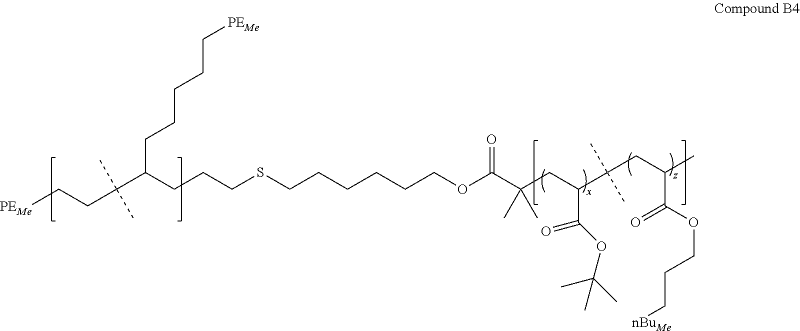

### Synthesis of Low MW polyolefin-b-poly(AA)-r-poly(nBA) (Compound B5)

In a glove box, Compound B4 (Mₙ=12.0 kDa (17 wt % tBA), 12.0 g, 16 mmol tert-butyl groups) was dissolved in 50 mL of toluene at 110° C. Trifluoroacetic acid (5.58 mL, 73.0 mmol, 4.6 equiv.) was added and the solution stirred at reflux for 10 minutes, then precipitated into 600 mL MeOH and filtered. The solid/gel was washed with an additional 400 mL of MeOH, and filtered again. The product was then dried under a stream of N₂ overnight at 70° C. to yield tan polymer (10.3 g, 90% yield). ¹H NMR (500 MHz, 110° C., d1=70 s, TCE-d₂:DMSO-d₆ 10:1 v/v) δ 7.74-6.63 (br, 14H, COOH), 4.02 (br, 29H, h), 2.60-2.18 (DMSO), 2.02-1.33 (br overlapping, 81H), 1.33-0.99 (br overlapping, 1118H), 0.99-0.78 (br, 54H, PE_{Me}+nBu_{Me}).

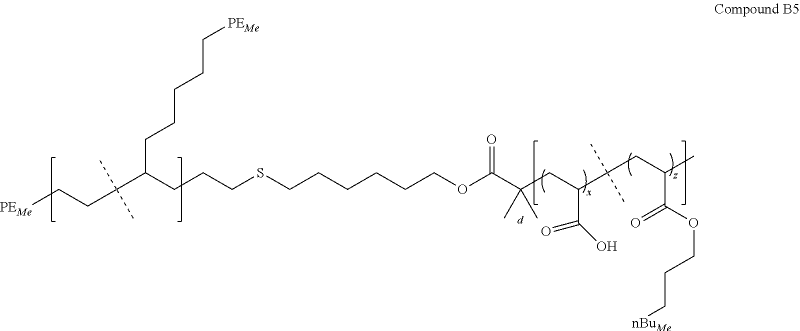

Reaction Sequence C

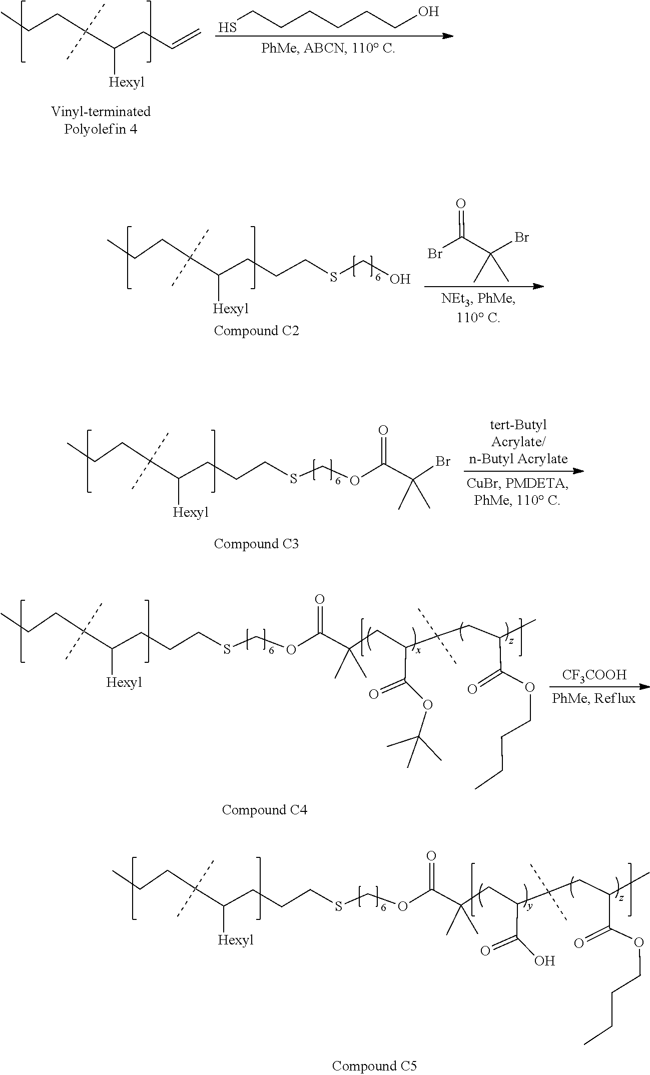

### Synthesis of Low MW polyolefin-b-poly(tBA)-r-oly(nBA) (Compound C4)

In a glove box, Compound C3, which was produced using the same sequence to synthesize Compound B2 (Mₙ=8.0 kDa, 10.0 g, 1.21 mmol —Br) was dissolved in 28 mL of toluene at 110° C. Tert-butyl acrylate (4.42 mL, 30.2 mmol, 25 equiv.) and n-butyl acrylate (10.1 mL, 70.5 mmol, 58 equiv.) were added was added and solution stirred until homogeneous. CuBr (173 mg, 1.21 mmol, 1 equiv.) and PMDETA (209 mg, 1.21 mmol, 1 equiv.) were added as a stock solution in benzonitrile (1.04 mL) and the reaction allowed to proceed for 1 hr. The reaction was terminated by removing from glovebox and exposing to air. The solution was diluted to 200 mL in hot toluene, washed with water, then 0.5 M EDTA solution until washings were nearly colorless, then precipitated twice into 800 mL MeOH and filtered. The product was dried under a stream of N₂ overnight at 70° C. to give tan polymer (17.0 g, 89% yield). ¹H NMR (500 MHz, 110° C., d1=70 s, TCE-d₂) δ 4.10 (br, 79H), 2.50-2.40 (br, 39H), 2.40-2.20 (br, 20H), 2.00-1.57 (br overlapping, 175H), 1.54-1.43 (br, 271H), 1.47-1.11 (br overlapping, 1118H, Polyolefin+other aliphatic), 1.04-0.92 (t, J=6.7 Hz, 128H, PE_{Me}+nBu_{Me}).

NMR indicated that the acrylate resonance was attached to a large molecule, with no evidence of small molecule acrylate.

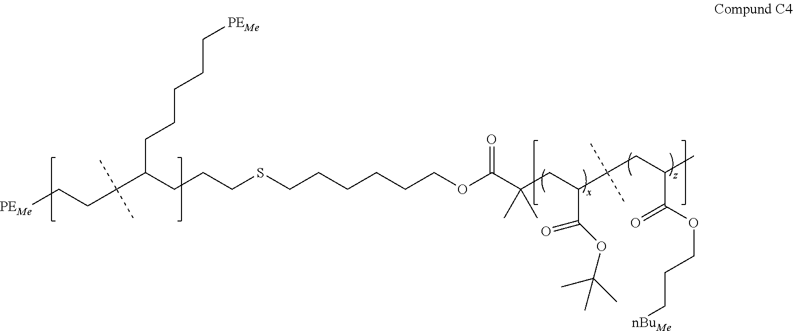

### Synthesis of Low MW polyolefin-b-poly(AA)-r-poly(nBA) (Compound C5)

In a glove box, Compound C4 (Mₙ=15.5 kDa (16 wt % tBA), 13.0 g, 16 mmol tert-butyl groups) was dissolved in 60 mL of toluene at 110° C. Trifluoroacetic acid (5.0 mL, 73.0 mmol, 4.0 equiv.) was added and the solution stirred at reflux for 10 minutes, then precipitated into 600 mL MeOH and filtered. The solid/gel was washed with an additional 400 mL of MeOH, and filtered again. The product was then dried under a stream of N₂ overnight at 70° C. to yield tan polymer (11.0 g, 88% yield). ¹H NMR (500 MHz, 110° C., d1=70 s, TCE-d₂:DMSO-d₆ 10:1 v/v) δ 9.50-8.20 (br, 11H, COOH), 4.02 (br, 77H), 2.45-2.18 (br, 62H), 2.02-1.33 (br overlapping, 379H), 1.33-0.99 (br overlapping, 1118H), 0.99-0.78 (br, 116H).

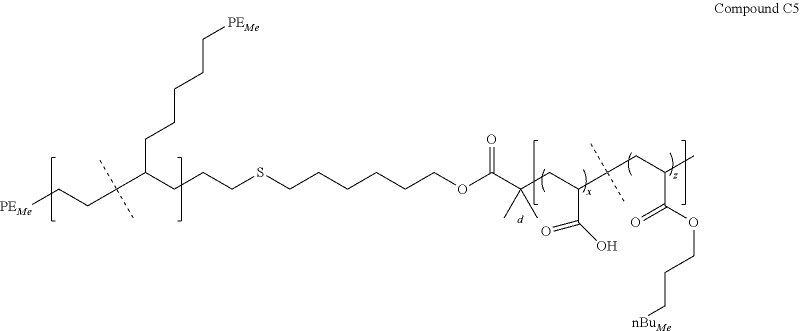

Reaction Sequence D

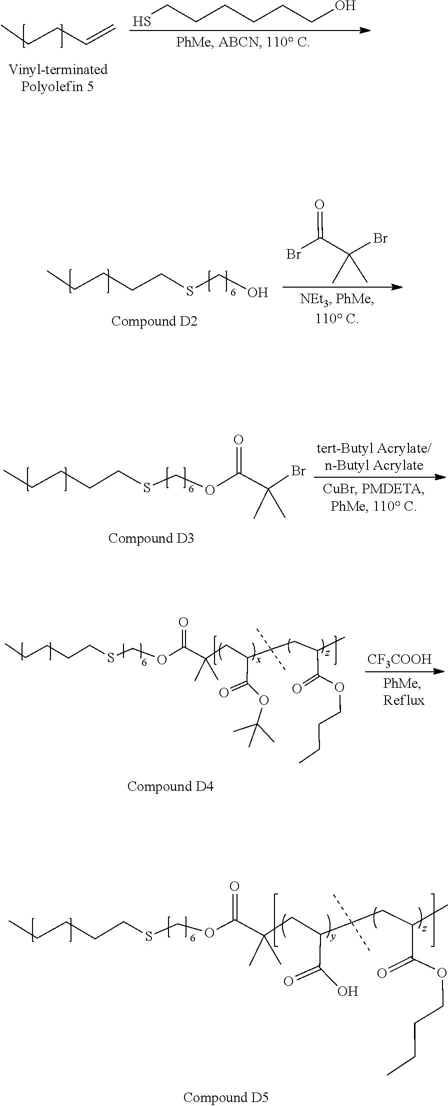

### Synthesis of Very Low MW hydroxyl-terminated polyolefin (Compound D2)

In a glovebox, Vinyl-terminated polyolefin 5 (Mₙ=1.5 kDa, 25.3 g, 16.6 mmol) was dissolved in 80 mL of toluene in a vented glass jar at 110° C. 6-Mercaptohexanol (6.80 mL, 47.8 mmol, 3 equiv.) was added in one portion, followed by ABCN (2.02 g, 8.3 mmol, 0.5 equiv.) in 10 mL of toluene. Reaction was stirred for 2 hr. at 110° C., then removed from the glovebox, precipitated into 800 mL of MeOH, filtered, and washed with an additional portion of MeOH. The product was then dried under a stream of N₂ overnight at 70° C. to give white polymer (26.5 g, 96% yield). ¹H NMR (500 MHz, 110° C., d1=70 s, TCE-d₂) δ 3.68 (q br, 2H, a), 2.55 (m br, 4H, c), 1.92-0.74 (br overlapping, 205H, Polyolefin+other aliphatic+PE_{Me}).

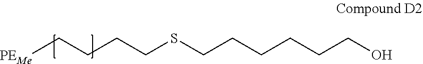

### Synthesis of Very Low MW Macroinitiator (Compound D3)

In a glove box, Compound D2 (Mₙ=1.5 kDa, 26.0 g, 17.6 mmol —OH) was dissolved in 120 mL of toluene in ajar at reflux. Triethylamine (7.30 mL, 52.7 mmol, 3 equiv.) was added, followed by the dropwise addition of 2-bromo-2-methylpropionyl bromide (4.35 mL, 35.1 mmol, 2 equiv.) diluted with 10 mL of toluene. The reaction was allowed to reflux for 30 minutes, then removed from the glovebox and precipitated into 800 mL of MeOH, filtered, then triturated with an additional 600 mL of MeOH and filtered again. The product was dried under a stream of N₂ overnight at 70° C. to give tan polymer (27.8 g, 97% yield). ¹H NMR (500 MHz, 110° C., d1=70 s, TCE-d₂) δ 4.25 (t br, 2H) 2.58 (m, 4H), 2.01 (s, 6H), 1.92-0.74 (br overlapping, 208H).

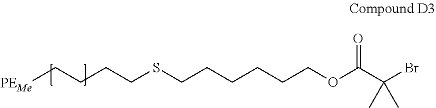

### Synthesis of Very Low MW polyolefin-b-poly(tBA)-r-poly(nBA) (Compound D4)

In a glove box: Compound D3 (Mₙ=1.7 kDa, 26.0 g, 15.6 mmol —Br) was dissolved in 180 mL of toluene at 110° C. in a 500 mL round bottom flask with stir bar. Tert-butyl acrylate (11.4 mL, 77.8 mmol, 5 equiv.) and n-butyl acrylate (33.4 mL, 234 mmol, 15 equiv.) were added was added and solution stirred until homogeneous. CuBr (2.23 g, 15.6 mmol, 1 equiv.) and PMDETA (2.70 g, 15.6 mmol, 1 equiv.) were added as a stock solution in benzonitrile (13.4 mL) and the reaction allowed to proceed for 30 min. The reaction was terminated by removing from the glovebox and exposing to air, then precipitated twice into 800 mL MeOH and filtered. The product was dried under a stream of N₂ overnight at 70° C. to give tan polymer (18.6 g, 35% yield)[*while conversion was good, the majority of product was lost due to spillage]. ¹H NMR (500 MHz, 110° C., d1=70 s, TCE-d₂) δ 4.10 (br, 25H, a+h), 2.50-2.40 (br, 13H, i+c), 2.40-2.20 (br, 6H, f), 2.00-1.57 (br overlapping, 53H), 1.54-1.43 (br, 63H, e+l), 1.47-1.11 (br, 208H, Polyolefin+other aliphatic), 1.04-0.92 (t, J=6.7 Hz, 38H).

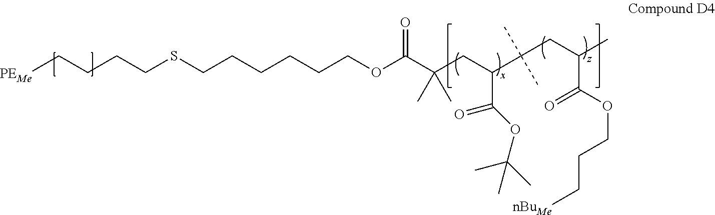

### Synthesis of Very Low MW polyolefin-b-poly(AA)-r-poly(nBA) (Compound D5)

Compound D4 (Mₙ=3.6 kDa (15 wt % tBA), 18.1 g, 16 mmol tert-butyl groups) was added to a 500 mL round bottom flask containing 200 mL of toluene, fitted with a reflux condenser, and stirred with an overhead stirrer with heating mantle set at 115° C. The mantle temperature was reduced to 105° C. and trifluoroacetic acid (16.1 mL, 211 mmol, 10 equiv.) was added and solution stirred for 1 hr. The heating mantle was then removed, reaction was cooled to room temperature, then precipitated in portions, into four 500 mL jars, each containing 300 mL MeOH. The combined portions were isolate by filtration and the resulting solid washed with methanol, filtered, and dried in a vacuum oven at 50° C. for 18 h to yield a light brown powder (13.77 g, 81% yield). An additional portion was obtained by allowing solid to settle from the supernatant and isolating in the same manner (0.90 g, 5.3% yield). Combined yield is 14.67 g (87%). ¹H NMR (500 MHz, 110° C., d1=70 s, TCE-d₂:DMSO-d₆ 10:1 v/v) δ 11.2-9.5 (br, 2H, COOH), 4.02 (br, 23H), 2.60-2.18 (br, 19H), 2.02-1.33 (br overlapping, 87H), 1.33-0.99 (br overlapping, 208H), 0.99-0.78 (br, 36H).

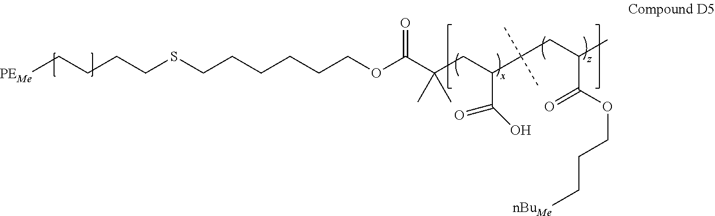

Reaction Sequence E

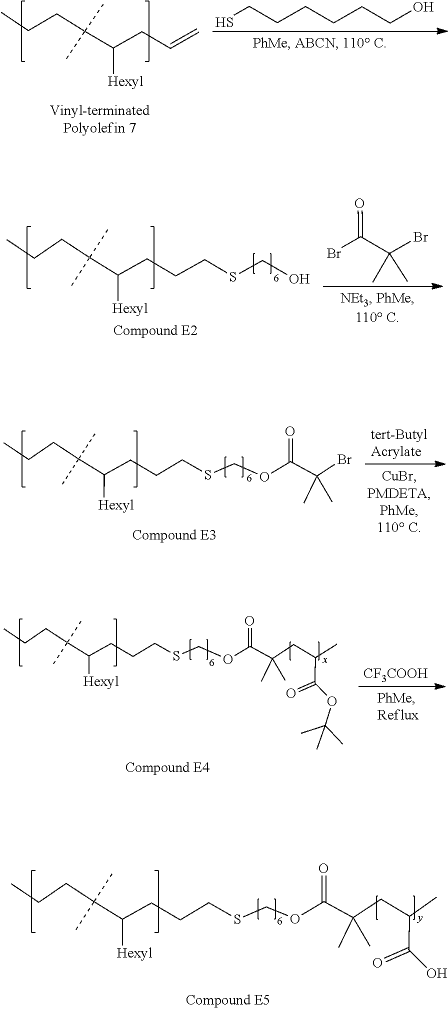

### Synthesis of High MW hydroxyl-terminated polyolefin (Compound E2)

In a glovebox, Vinyl-terminated polyolefin 7 (Mₙ=26.6 kDa, 23.1 g, 0.87 mmol) was dissolved in 125 mL of toluene in a vented round bottom flask at reflux. 6-Mercaptohexanol (1.20 mL, 9.0 mmol, 10 equiv.) was added in one portion, followed by ABCN (218 mg, 0.89 mmol, 1 equiv.) in 5 mL of toluene. Reaction was stirred for 2 hr, at which time an additional portion of 6-Mercaptohexanol (1.20 mL, 9.0 mmol, 10 equiv.) and ABCN (218 mg, 0.89 mmol, 1 equiv.) were added. After an additional 2 hr, the reaction was removed from the glovebox, precipitated into 800 mL of MeOH, filtered, and washed with an additional portion of MeOH. The product was then dried under a stream of N₂ overnight at 70° C. to give white polymer (22.6 g, 97% yield). ¹H NMR (500 MHz, 110° C., d1=70 s, TCE-d₂) δ 3.68 (m br, 2H), 2.55 (m br, 4H), 1.92-0.74 (br overlapping, 4433H).

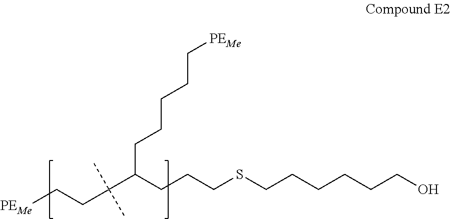

### Synthesis of High MW Macroinitiator (Compound E3)

In a glove box, Compound E2 (Mₙ=31.0 kDa, 22.5 g, 0.73 mmol —OH) was dissolved in 135 mL of toluene in a round bottom at reflux. Triethylamine (1.56 mL, 11.3 mmol, 15.6 equiv.) was added, followed by the dropwise addition of 2-bromo-2-methylpropionyl bromide (0.84 mL, 0.68 mmol, 9.4 equiv.) diluted with 10 mL of toluene. The reaction was allowed to reflux for 30 minutes, then removed from the glovebox, precipitated into 800 mL of MeOH, filtered, then triturated with an additional 600 mL of MeOH and filtered again. The product was dried under a stream of N₂ overnight at 70° C. to give tan in quantitative yield. ¹H NMR (500 MHz, 110° C., d1=70 s, TCE-d₂) δ 4.25 (t br, 2H), 2.58 (m, 4H), 2.01 (s, 6H), 1.78-1.74 (br overlapping, 4265H).

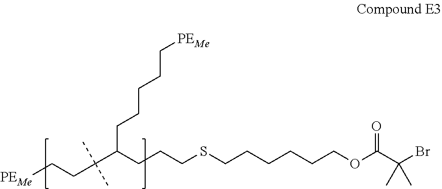

### Synthesis of High MW polyolefin-b-poly(tBA) (Compound E4)

In a glove box, Compound E3 (Mₙ=30.0 kDa, 10.0 g, 0.33 mmol —Br) was dissolved in 50 mL of toluene at 110° C. Tert-butyl acrylate (10.6 mL, 72.7 mmol, 218 equiv.) was added and solution stirred until homogeneous. CuBr (48 mg, 0.33 mmol, 1 equiv.) and PMDETA (0.069 mL, 0.33 mmol, 1 equiv.) were added as a stock solution in benzonitrile (0.29 mL) and the reaction allowed to proceed for 5 hr. The reaction was terminated by removing from glovebox and exposing to air. The solution was then precipitated twice into 800 mL MeOH, filtered, and washed with two additional portions of 500 mL MeOH until the polymer was colorless. The product was dried under a stream of N₂ overnight at 70° C. to give white polymer in quantitative yield. ¹H NMR (500 MHz, 110° C., d1=70 s, TCE-d₂) δ 4.09 (t br, J=5.3, 2H), 2.55 (t br, J=7.4, 5H), 2.40-2.20 (br, 48H), 2.00-1.57 (br overlapping, 93H), 1.51 (s br, 486H), 1.47-1.11 (br, 4234H), 0.96 (t, J=6.7, 39H).

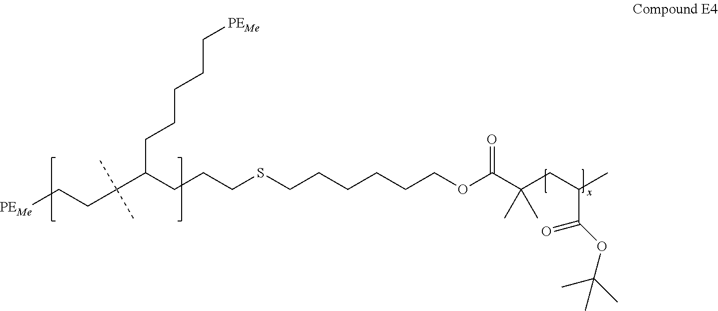

### Synthesis of Low MW polyolefin-b-poly(AA) (Compound E5)

Compound E4 (Mₙ=36.9 kDa, 10.8 g, 19 wt % tBA, 16.0 mmol tert-butyl groups) was added to a 500 mL round bottom flask equipped with a reflux condenser and a mechanical stirrer, and toluene (200 mL) was added. The mixture was stirred at reflux (heating mantle set to 115° C.) until a clear, viscous solution was obtained (approximately 20 min). The heating mantle temperature was reduced to 105° C., and trifluoroacetic acid (12.3 mL, 160 mmol, 10 equiv.) was rapidly added to the mixture. The reaction was allowed to stir at 105° C. for 1 h. The heating mantle was removed and the reaction was allowed to cool to room temperature. The resulting gel/paste was precipitated into ajar containing rapidly stirring methanol (3 jars each with 350 mL), resulting in the formation of a milky white suspension. The suspension were combined, filtered, washed with methanol, and dried in a vacuum oven at 50° C. for 18 h to yield a white powder (9.61 g, 97% yield). ¹H NMR (500 MHz, 110° C., d1=70 s, TCE-d₂:DMSO-d₆ 10:1 v/v) δ 11.50-10.50 (br, 43H, COOH), 1.28-0.99 (br, 4234H, polyolefin), 0.89-0.84 (br, 52H, PE_{Me})

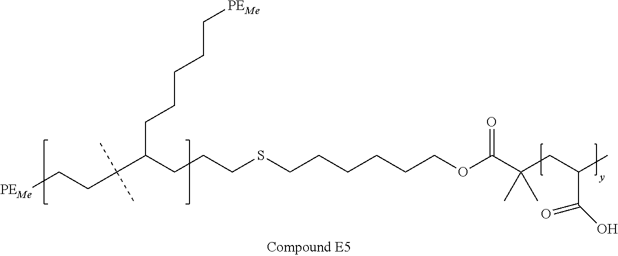

Reaction Sequence F

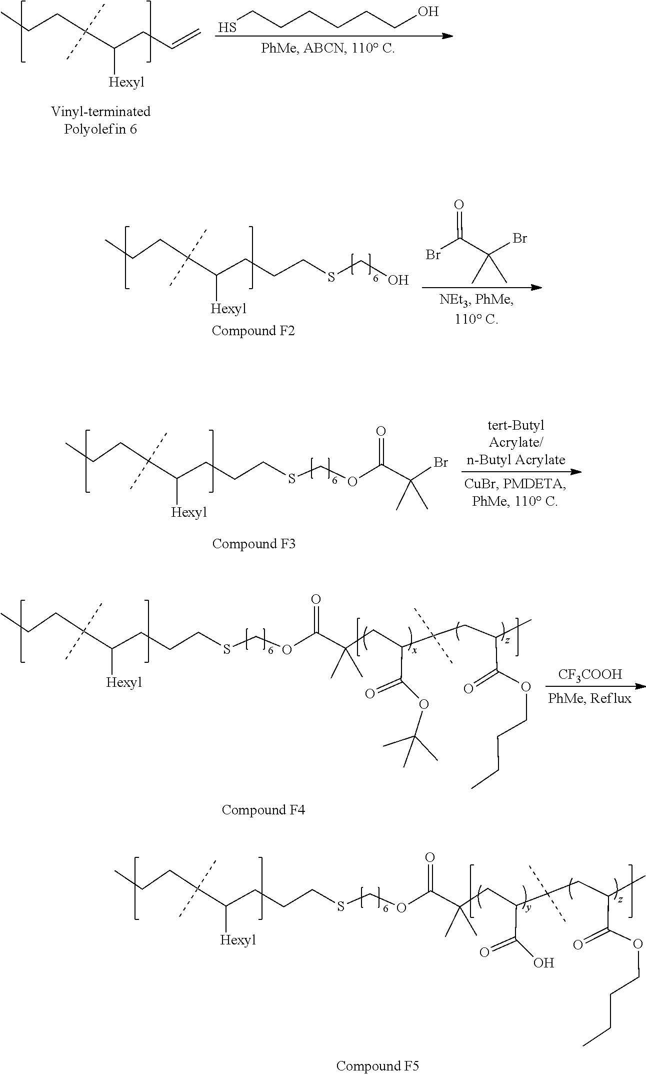

### Synthesis of High MW hydroxyl-terminated polyolefin (Compound F2)

In a glovebox: Vinyl-terminated polyolefin 6 (Mₙ=25.8 kDa, 25.5 g, 0.99 mmol) was dissolved in 227 mL of toluene at reflux in a vented 500 mL round bottom flask with stir bar. 6-Mercaptohexanol (1.11 mL, 8.13 mmol, 8.2 equiv.) was added in one portion, followed by ABCN (132 mg, 0.54 mmol, 0.54 equiv.) in 5 mL of toluene. Reaction was stirred for 2 hr. at reflux, then additional portions of 6-Mercaptohexanol (1.11 mL, 8.13 mmol, 8.2 equiv.) and ABCN in 5 mL toluene (132 mg, 0.54 mmol, 0.54 equiv.) were added and the reaction continued for another 2 hr. The reaction was then removed from the glovebox, cooled, precipitated into 750 mL of MeOH, filtered, and washed with an additional portion of MeOH. The product was then dried under a stream of N₂ overnight at 70° C. to give white polymer (24.7 g, 96% yield). ¹H NMR (500 MHz, 110° C., d1=70 s, TCE-d₂) δ 3.68 (br, 2H, a), 2.55 (m br, 4H, c), 1.92-0.74 (br, 4264H, Polyolefin, overlapping methylenes, PE_{Me}).

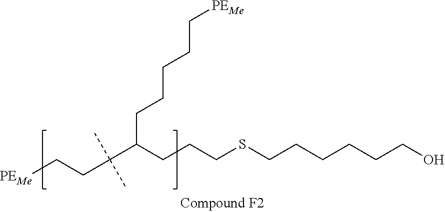

### Synthesis of High MW Macroinitiator (Compound F3)

In a glove box, Compound F2 (Mₙ=29.8 kDa, 24.7 g, 0.83 mmol —OH) was dissolved in 145 mL of toluene in a 500 mL round bottom flask at reflux. Triethylamine (1.71 mL, 12.4 mmol, 15 equiv.) was added dropwise, followed by the dropwise addition of 2-bromo-2-methylpropionyl bromide (0.92 mL, 7.4 mmol, 9 equiv.) diluted with 5 mL of toluene. The reaction was allowed to reflux for 75 minutes, then removed from the glovebox and precipitated into 800 mL of MeOH, filtered, then triturated with an additional 600 mL of MeOH and filtered again. The product was dried under a stream of N₂ overnight at 70° C. to give tan polymer (24.7 g, 99% yield). ¹H NMR (500 MHz, 110° C., d1=70 s, TCE-d₂) δ 4.25 (t br, 2H), 2.58 (br, 4H), 2.01 (s, 6H), 1.78-1.74 (br overlapping, 4638H).

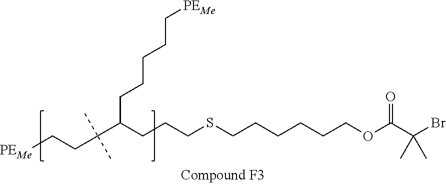

### Synthesis of High MW polyolefin-b-poly(tBA)-r-poly(nBA) (Compound F4)

In a glove box, Compound F3 (Mₙ=32.3 kDa, 10.0 g, 0.31 mmol —Br) was dissolved in 50 mL of toluene at 110° C. in a 250 mL glass jar with stir bar. Tert-butyl acrylate (10.8 mL, 74 mmol, 250 equiv.) and n-butyl acrylate (10.6 mL, 74 mmol, 250 equiv.) were added was added and solution stirred until homogeneous. CuBr (42 mg, 0.3 mmol, 1 equiv.) and PMDETA (51 mg, 0.3 mmol, 1 equiv.) were added as a stock solution in benzonitrile (0.255 mL) and the reaction allowed to proceed for 5 hr. The reaction was terminated by removing from glovebox and exposing to air. The slurry was then precipitated into 800 mL MeOH and filtered, rinsing with excess MeOH. The product was dried under a stream of N₂ overnight at 70° C. to give white polymer (15.5 g, 98% yield). ¹H NMR (500 MHz, 110° C., d1=70 s, TCE-d₂) δ 4.10 (br, 149H), 2.50-2.40 (br, 75H), 2.40-2.20 (br, 80H), 2.00-1.57 (br overlapping, 434H), 1.54-1.43 (br, 934H), 1.47-1.11 (br, 4621H), 1.04-0.92 (t, J=6.7, 268H).

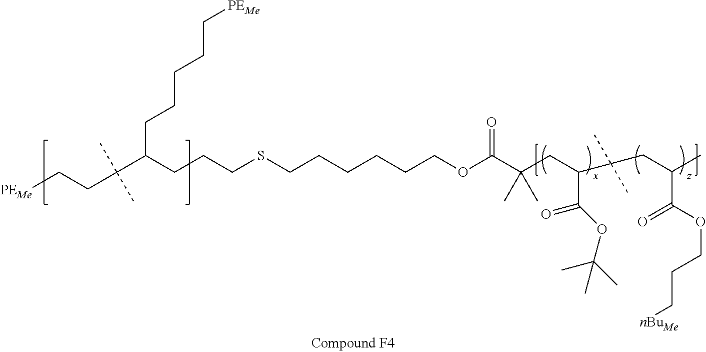

### Synthesis of High MW polyolefin-b-poly(AA)-r-poly(nBA) (Compound F5)

Compound F4 (Mₙ=51.2 kDa, 14.0 g, 18 wt % tBA, 19.7 mmol tert-butyl groups) was added to a 500 mL round bottom flask equipped with a reflux condenser and a mechanical stirrer, and toluene (200 mL) was added. The mixture was stirred at reflux (heating mantle set to 115° C.) until a clear, viscous solution was obtained (approximately 20 min). The heating mantle temperature was reduced to 105° C., and trifluoroacetic acid (15.0 mL, 196 mmol, 10 equiv.) was rapidly added to the mixture. The reaction was allowed to stir at 105° C. for 1 h. The heating mantle was removed and the reaction was allowed to cool to room temperature. The resulting suspension was precipitated into ajar containing rapidly stirring methanol (3 jars each with 350 mL), resulting in the formation of a milky white suspension. The suspension were combined, filtered, washed with methanol, and dried in a vacuum oven at 50° C. for 18 h to yield a white powder (12.2 g, 95% yield). ¹H NMR (500 MHz, 110° C., d1=70 s, TCE-d₂:DMSO-d₆ 10:1 v/v) δ 11.37-9 (br, 47H, COOH), 4.02 (br, 144H, h), 2.45-2.18 (br, 133H), 2.02-1.33 (br overlapping, 678H), 1.33-0.99 (br, 4621H), 0.99-0.78 (br, 259H).

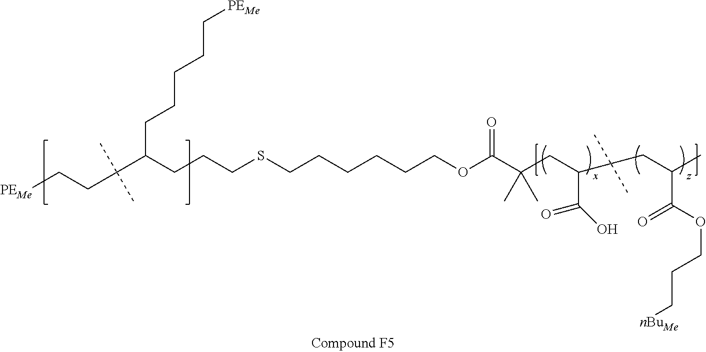

Reaction Sequence G

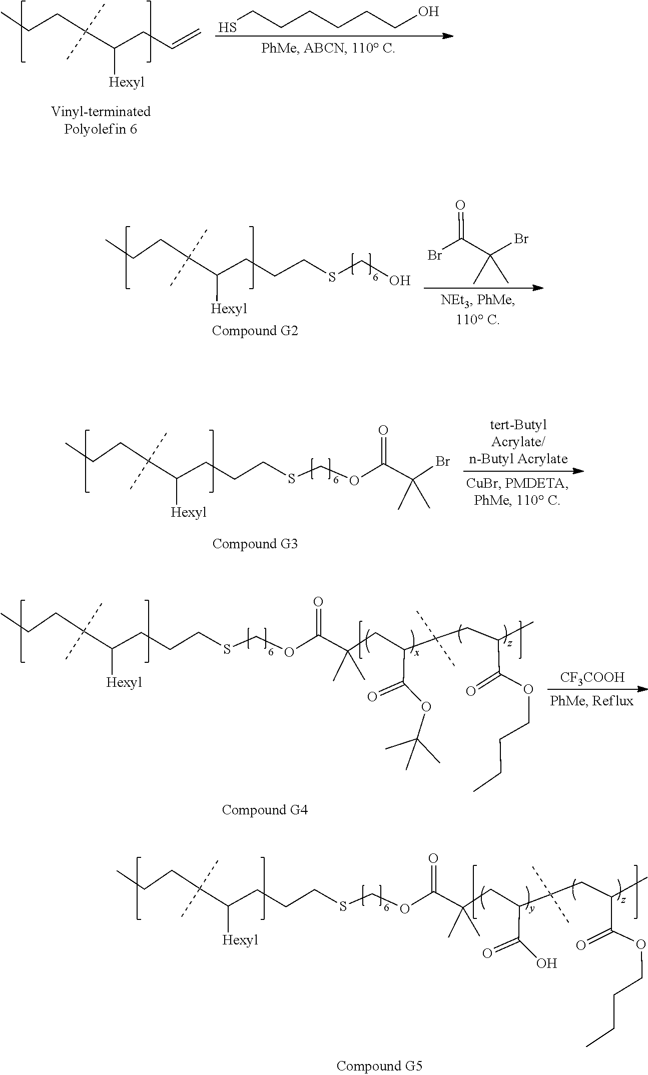

### Synthesis of High MW polyolefin-b-oly(tBA)-r-poly(nBA) (Compound G4)

In a glove box, Compound G3, which was produced using the same sequence to synthesize Compound F2 (Mₙ=32.3 kDa, 10.0 g, 0.31 mmol —Br) was dissolved in 50 mL of toluene at 110° C. in a 250 mL glass jar with a stir bar. Tert-butyl acrylate (10.8 mL, 74 mmol, 250 equiv.) and n-butyl acrylate (24.7 mL, 173 mmol, 583 equiv.) were added was added and solution stirred until homogeneous. CuBr (42 mg, 0.3 mmol, 1 equiv.) and PMDETA (51 mg, 0.3 mmol, 1 equiv.) were added as a stock solution in benzonitrile (0.255 mL) and the reaction allowed to proceed for 5 hr. The reaction was terminated by removing from glovebox and exposing to air. The slurry was then precipitated into 800 mL MeOH, filtered, and washed with excess MeOH. The product was dried under a stream of N₂ overnight at 70° C. to give white polymer (17.2 g, 97% yield). ¹H NMR (500 MHz, 110° C., d1=70 s, TCE-d₂) δ 4.10 (br, 311H), 2.50-2.40 (br, 127H), 2.40-2.20 (br, 85H), 2.00-1.57 (br overlapping, 702H), 1.54-1.43 (br, 1075H, e+l), 1.47-1.11 (br, 4621H), 1.04-0.92 (t, J=6.7, 502H)

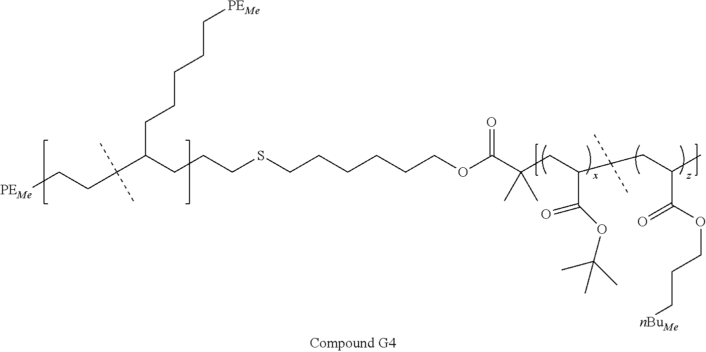

### Synthesis of High MW polyolefin-b-poly(AA)-r-poly(nBA) (Compound G5)

Compound G4 (Mₙ=60.8 kDa, 16.7 g, 14 wt % tBA, 18.1 mmol tert-butyl groups) block copolymer was added to a 500 mL round bottom flask equipped with a reflux condenser and a mechanical stirrer, and toluene (200 mL) was added. The mixture was stirred at reflux (heating mantle set to 115° C. for 50 min then 125° C. for 30 min) until a clear, viscous solution was obtained. The heating mantle temperature was reduced to 105° C., and trifluoroacetic acid (13.9 mL, 181 mmol, 10 equiv.) was rapidly added to the mixture. The reaction was allowed to stir at 105° C. for 1 h. The heating mantle was removed and the reaction was allowed to cool to room temperature. The resulting paste/gel was precipitated into a jar containing rapidly stirring methanol (4 jars each with 350 mL), resulting in the formation of a milky white suspension. The suspension were combined, filtered, washed with methanol, and dried in a vacuum oven at 50° C. for 18 h to yield a white powder (14.8 g, 95% yield). ¹H NMR (500 MHz, 110° C., d1=70 s, TCE-d₂:DMSO-d₆ 10:1 v/v) δ 11.37-9.20 (br, 38H, COOH), 4.02 (br, 286H, h), 2.45-2.18 (br, 189H, i+f), 2.02-1.33 (br overlapping, 1062H, g/g′+j/j′+k+l), 1.33-0.99 (br, 4621H, polyolefin), 0.99-0.78 (br, 471H, PE_{Me}+nBu_{Me})

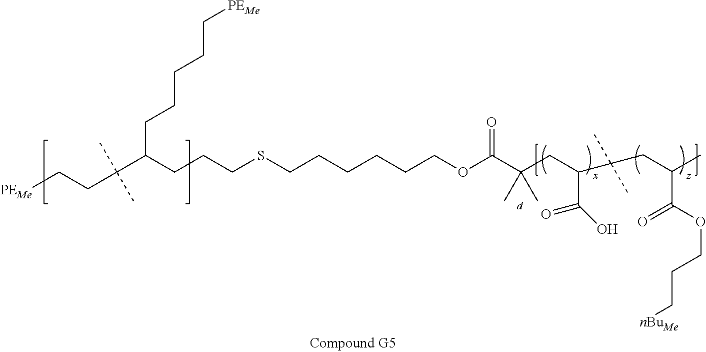

Reaction Sequence H

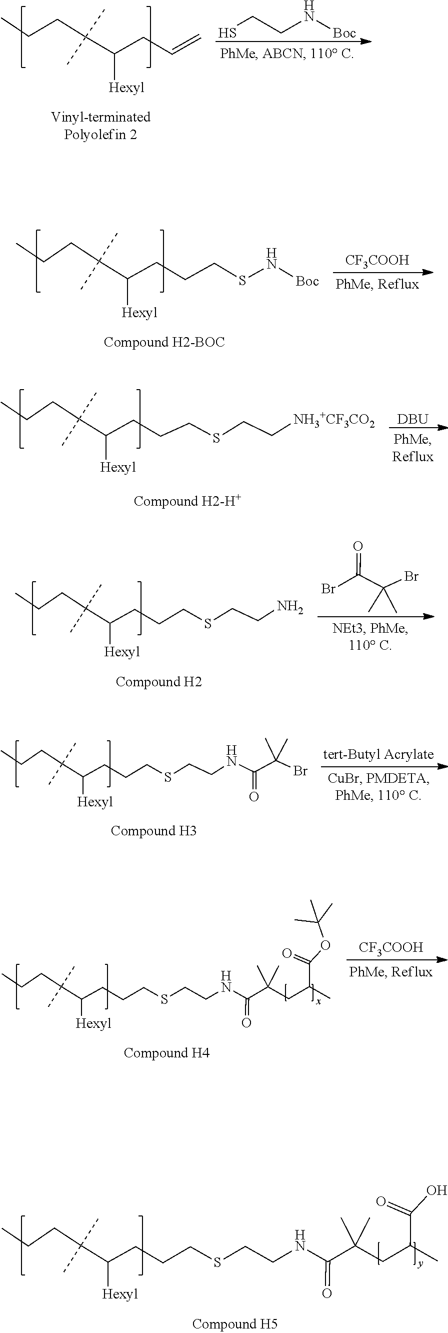

### Synthesis of Low MW NH-Boc-Terminated Polyolefin (Compound H2-BOC)

In a glovebox, vinyl-terminated polyolefin 2 (Mₙ=4.2 kDa, 20.4 g, 5.1 mmol) was dissolved in 60 mL of toluene in a vented glass jar. 2-(Boc-amino)ethanethiol (4.06 mL, 24 mmol, 4.7 equiv.) was added in one portion, followed by ABCN (588 mg, 2.40 mmol, 0.47 equiv.) in 2 mL of toluene. Reaction was stirred for 4 hr. at 110° C., then removed from the glovebox, precipitated into 600 mL of MeOH, filtered, and washed with an additional 400 mL portion of MeOH. The product was then dried under a stream of N₂ overnight at 70° C. to give white polymer (20.8 g, 98% yield). ¹H NMR (500 MHz, 110° C., d1=70 s, TCE-d₂) δ 4.76 (br, 1H, NH), 3.34 (q, J=6.5 Hz, 2H, a), 2.69 (t, J=6.6 Hz, 2H, b), 2.58 (t, J=7.3 Hz, 2H, c), 1.78 (m, 2H, d), 1.65 (s, 9H, e), 1.49-0.89 (br, 691H).

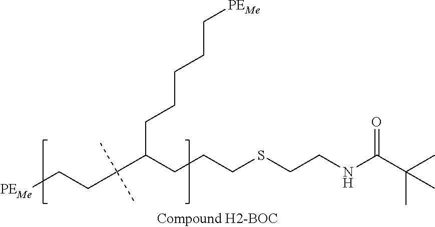

### Synthesis of Low MW NH₃-TFA-Terminated Polyolefin (Compound H2-H⁺)

In a glove box, Compound H2-BOC (Mₙ=4.8 kDa, 20.0 g, 4.17 mmol) was dissolved in 40 mL of toluene at 110° C. Trifluoroacetic acid (3.0 mL, 39 mmol, 9.5 equiv.) was added and solution stirred at reflux for 30 minutes, then precipitated into 500 mL MeOH and filtered. The solid was washed with an additional 300 mL of MeOH and filtered again. The product was then dried under a stream of N₂ overnight at 70° C. to yield tan polymer in quantitative yield. ¹H NMR (500 MHz, 110° C., d1=70 s, TCE-d₂) δ 5.00 (br, 3H, NH₃⁺), 3.23 (br, 2H, a), 2.90 (t, J=7.4 Hz, 2H), 2.60 (t, J=7.4 Hz, 2H), 1.66 (m, 2H, d), 1.56-0.85 (br, 772H).

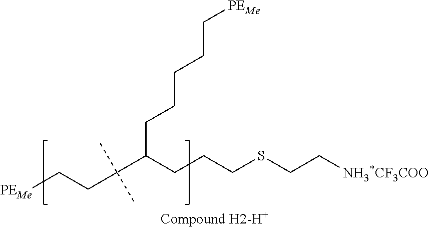

### Synthesis of Low MW amine-terminated polyolefin (Compound H3)

In a glove box, Compound H2-H⁺ (Mₙ=5.1 kDa, 17.0 g, 3.33 mmol) was dissolved in 80 mL of toluene at 110° C. 1,8-Diazabicyclo[5.4.0]undec-7-ene (DBU) (0.94 mL, 6.3 mmol, 1.9 equiv.) was added and solution stirred at reflux for 20 minutes, then precipitated into 800 mL MeOH, filtered, and washed with an additional 500 mL portion of MeOH. The product was then dried under a stream of N₂ overnight at 70° C. to yield tan polymer in quantitative yield. ¹H NMR (500 MHz, 110° C., d1=70 s, TCE-d₂) δ 2.99 (br, 2H, a), 2.71 (br, 2H, b), 2.60 (t, J=7.2 Hz, 2H, c), 1.68 (m, 2H, d), 1.61-0.89 (br, 713H, Polyolefin+PE_{Me}).

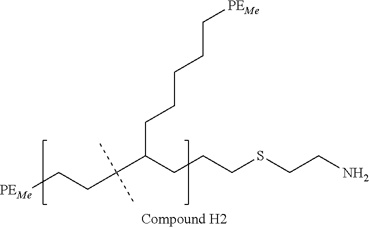

### Synthesis of Low MW amide-linked Macroinitiator (Compound H3)

In a glove box, Compound H2 (Mₙ=5.0 kDa, 16.0 g, 3.2 mmol —NH₂) was dissolved in 48 mL of toluene in ajar at reflux. Triethylamine (2.63 mL, 19.0 mmol, 5.9 equiv.) was added, followed by the dropwise addition of 2-bromo-2-methylpropionyl bromide (1.57 mL, 12.7 mmol, 4 equiv.) diluted with 5 mL of toluene. The reaction was allowed to reflux for 75 minutes, then removed from the glovebox, precipitated into 800 mL of MeOH, filtered, then triturated with an additional 600 mL of MeOH and filtered again. The product was dried under a stream of N₂ overnight at 70° C. to give tan polymer in quantitative yield. ¹H NMR (500 MHz, 110° C., d1=70 s, TCE-d₂) δ 6.90 (br, 1H, NH), 3.50 (td, J=6.4, 6.2 Hz, 2H, a), 2.74 (t, J=6.6 Hz, 2H, b), 2.61 (t, J=7.3 Hz, 2H, c), 2.01 (s, 6H, e), 1.66 (m, 2H, d), 1.59-0.84 (br, 750H).

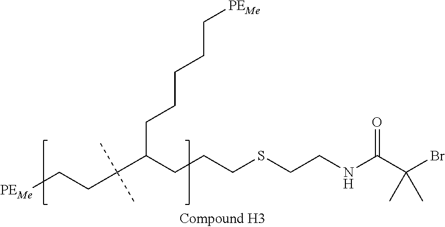

### Synthesis of Low MW amide-linked polyolefin-b-poly(tBA) (Compound H4)

In a glove box, Compound H3 (Mₙ=5.3 kDa, 15.0 g, 2.8 mmol —Br) was dissolved in 60 mL of toluene at 110° C. Tert-butyl acrylate (19.5 mL, 133 mmol, 47 equiv.) was added and solution stirred until homogeneous. CuBr (384 mg, 2.7 mmol, 0.95 equiv.), CuBr₂ (32 mg, 0.14 mmol, 0.05 equiv.) and PMDETA (0.590 mL, 2.8 mmol, 1 equiv.) were added as a stock solution in benzonitrile (2.3 mL) and the reaction allowed to proceed for 75 min. The reaction was terminated by removing from glovebox and exposing to air. The solution was diluted to 200 mL in hot toluene and washed with water, then 0.5 M EDTA solution until washings were nearly colorless, then precipitated twice into 800 mL MeOH and filtered. The product was dried under a stream of N₂ overnight at 70° C. to give tan polymer (21.4 g, 80% yield). ¹H NMR (500 MHz, 110° C., d1=70 s, TCE-d₂) δ 3.44 (br, 2H, a), 2.69 (br, 2H, b), 2.57 (br, 2H, c), 2.32 (br, 24H, g), 2.00-1.58 (br overlapping 48H, h/h′+e), 1.51 (br s, 260H), 1.51-0.86 (br, 750H).

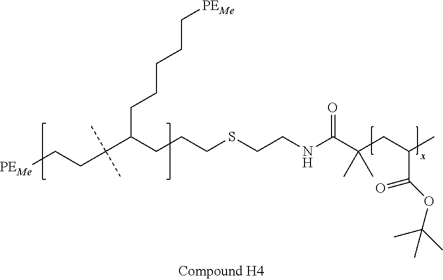

### Synthesis of Low MW amide-linked polyolefin-b-poly(AA)-r-poly(nBA) (Compound H5)

In a glove box, Compound H4 (Mₙ=5.3 kDa, 41 wt % tBA, 21.0 g, 67 mmol tert-butyl groups) was dissolved in 120 mL of toluene at 110° C. Trifluoroacetic acid (26.0 mL, 336 mmol, 5 equiv.) was added and solution stirred at reflux for 10 minutes, then precipitated into 600 mL MeOH and filtered. The solid/gel was washed with an additional 400 mL of MeOH, and filtered again. The product was then dried under a stream of N₂ overnight at 70° C. to yield tan polymer (16.2 g, 94% yield). ¹H NMR (500 MHz, 110° C., d1=70 s, TCE-d₂:DMSO-d₆ 10:1 v/v) δ 10.00-8.10 (br, 25H, COOH), 1.46-0.75 (br, 750H).

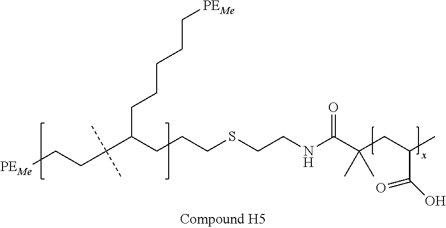

For each of the Reaction Sequence A to H, the amount of polymer with end functionalization (specifically, vinyl terminated polyolefin) was determined by quantitative ¹³C NMR.

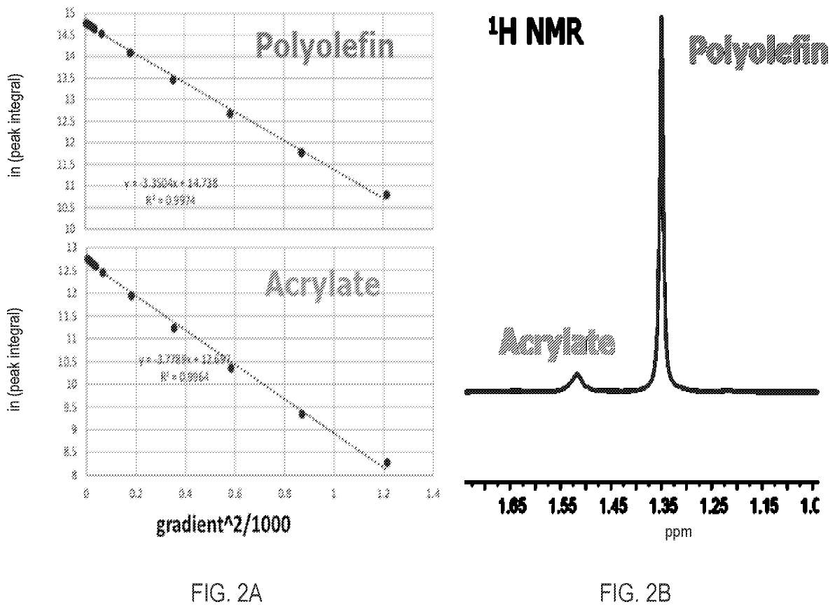

FIG. 2A is a graph of the natural log of the integral of the proton NMR (¹H NMR) signal of tert-butyl resonance from the polar block or the methylene (CH₂) resonance from the non-polar block as a function of the gradient²/1000. In FIG. 2A, there are two linear lines, one according to the methylene in the polyethylene and the other charting the tert-butyl resonance in the polar block. Both lines have approximately the same slope, thus indicating that the acrylate monomers polymerized on in a controlled mechanism from the macroinitiator. Therefore, FIG. 2 indicates that the non-polar (polyethylene) block and the polar (polyacrylate) block are connected.

Although some examples include units derived from octene in the non-polar block, the amount of methylene derived from octene in the non-polar block is small enough to be considered negligible.

The results in the graph as shown in FIG. 2 were calculated using the procedure described in: “Molecular mass estimation by PFG NMR spectroscopy” by Crutchfield, C. A., and Harris, D. J. Journal of Magnetic Resonance, 185 (2007) 179-182.

### Example 7—Polymerization Results

TABLE 2
Results of the synthesis of hydroxyl-functional
polyolefins using thiol-ene addition (Compound 2)

| | | | | | Product |
|---|---|---|---|---|---|
| | [vinyl] | Thiol | ABCN | Yield | M_{n, effective} |
| Compound | [mM] | [equiv.] | [equiv.] | [%] | [kDa] |
| Compound A2 | 60 | 5 | 0.5 | 94 | 8.0 |
| Compound | 53 | 5 | 0.5 | quant. | 7.7 |
| B2 & C2 | | | | | |
| Compound D2 | 200 | 3 | 0.5 | 96 | 1.5 |
| Compound E2 | 7 | 20 | 2 | 97 | 31.0 |
| Compound | 6 | 16 | 1 | 96 | 29.8 |
| F2 & G2 | | | | | |

TABLE 3
Results of the synthesis of polyolefin ATRP macroinitiators
via esterification (Compound 3)

| | | | | | Product |
|---|---|---|---|---|---|
| | [—OH] | 2-BMPB | NEt₃ | Yield | M_{n, effective} |
| Compound | [mM] | [equiv.] | [equiv.] | [%] | [kDa] |
| Compound A3 | 36 | 4 | 5 | 96 | 8.4 |
| Compound | 33 | 4 | 5 | quant. | 8.0 |
| B3 & C3 | | | | | |
| Compound D3 | 147 | 3 | 2 | 97 | 1.7 |
| Compound E3 | 7 | 9 | 16 | quant. | 30.0 |
| Compound | 6 | 9 | 15 | 99 | 32.3 |
| F3 & G3 | | | | | |

TABLE 4
Results of the synthesis of polyolefin-acrylate diblock
copolymers via ATRP (Compound 4)

| | | Polyolefin | | | | |
|---|---|---|---|---|---|---|
| | Product | Block | tBA | nBA | | Wt % |
| | M_{n,effective} | M_{n,effective} | units | units | Yield | Acrylate |
| Compound | [kDa] | [kDa] | [x] | [z] | [%] | [%] |
| Compound A4 | 10.7 | 8.4 | 18 | — | 88 | 22 |
| Compound B4 | 12.0 | 8.0 | 16 | 15 | 82 | 33 |
| Compound C4 | 15.6 | 8.0 | 19 | 40 | 89 | 49 |
| Compound D4 | 3.6 | 1.5 | 4 | 13 | 35* | 58 |
| Compound E4 | 36.9 | 30.0 | 54 | — | quant. | 19 |
| Compound F4 | 51.2 | 32.3 | 74 | 74 | 98 | 37 |
| Compound G4 | 60.8 | 32.3 | 67 | 156 | 97 | 47 |

*Low yield due to loss from spilling sample. Conversion was ~70% as targeted.

TABLE 5
Parameters of deprotected diblock copolymers.

| | | Polyolefin | | | | |
|---|---|---|---|---|---|---|
| | Product | Block | AA | nBA | | Wt % |
| | M_{n,effective} | M_{n,effective} | units | units | Yield | Acrylate |
| Compound | [kDa] | [kDa] | [x] | [z] | [%] | [%] |
| Compound A5 | 9.7 | 8.4 | 18 | — | 90 | 13 |
| Compound B5 | 11.1 | 8.0 | 16 | 15 | 90 | 28 |
| Compound C5 | 14.5 | 8.0 | 19 | 40 | 88 | 45 |
| Compound D5 | 3.4 | 1.5 | 4 | 13 | 95 | 56 |
| Compound E5 | 33.9 | 30.0 | 54 | — | 97 | 12 |
| Compound F5 | 47.1 | 32.3 | 74 | 74 | 95 | 31 |
| Compound G5 | 57.1 | 32.3 | 67 | 156 | 95 | 43 |

1. A method for preparing a non-polar-polar diblock copolymer, the method comprising:
polymerizing one or more olefin monomers in the presence of an alkyl aluminum chain transfer agent to produce a polymeryl aluminum species, which is then heated to produce a vinyl-terminated polyolefin;
reacting a thiol compound with the vinyl terminated polyolefin to form a sulfide containing polyolefin intermediate, wherein the thiol compound comprises a terminal hydroxyl or a protected terminal amine;
producing a macroinitiator by reacting the sulfide containing polyolefin intermediate with a linker, wherein the linker comprises an acyl halide and a halogen atom bonded to the alpha carbon to the acyl halide;
reacting the macroinitiator, a radical reagent, and CH₂═CH—(X) monomers via reversible-deactivation radical polymerization reaction to produce the non-polar-polar diblock copolymer, where X is —C(O)OR, —CN, or —C(O)NHR, wherein R is chosen from —H, linear (C₁-C₁₈)alkyl, or branched (C₁-C₁₈)alkyl.

2. The method of claim 1, wherein the CH₂═CH—(X) monomers comprise CH₂═CHC(O)(OR), glycidyl acrylate, or combination thereof, where each R is chosen from —H, linear (C₁-C₁₈)alkyl, or branched (C₁-C₁₈)alkyl.

3. The method of claim 1, wherein the CH₂═CH—(X) monomers comprise at least one t-butyl acrylate.

4. The method of claim 3, wherein the method further comprises reacting the non-polar-polar diblock copolymer under thermal or acidic conditions to form non-polar-polar acid diblock copolymer, wherein the thermal conditions comprise a temperature greater than 20° C.

5. The method of claim 1, wherein the thiol compound has a structure according to: 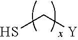
where x is 2 to 12; Y is-NHR^{B} or —OH, wherein R^{B} is a protecting group.

6. The method of claim 5, wherein Y is —NHR^{B}.

7. The method of claim 5, wherein the method further comprises deprotecting the protected terminal amine.

8. The method of claim 1, wherein during the reacting of the thiol compound with the vinyl-terminated polyolefin, —SH groups of the thiol compound react with the terminal vinyl group of the vinyl-terminated polyolefin to produce the sulfide-containing polyolefin intermediate.

9. The method of claim 1, wherein the polyolefin comprises monomers derived from ethylene and optionally further comprises one or more (C₃-C₁₂)α-olefin monomers.

10. The method of claim 1, wherein the halogen atom bonded to the alpha carbon of the linker is bromine or iodine.

11. The method of claim 1, wherein the radical reagent comprises a copper(I) halide chosen from CuBr, CuCl, or CuI.

12. The method of claim 1, wherein the radical reagent is CuBr.

13. The method of claim 1, wherein the radical reagent comprises CuX, Fe(III)X₃, or Ru(III)X₃ wherein X is a ligand selected from the group consisting of 2,2′:6′,2″-terpyridine (tpy), 2,2′-bipyridine (bpy), 4,4′-di(5-nonyl)-2,2′-bipyridine (dNbpy), N,N,N′,N′-tetramethylethylenediamine (TMEDA), N-propyl(2-pyridyl)methanimine (NPrPMI), 4,4′,4″-tris(5-nonyl)-2,2′:6′,2″-terpyridine (tNtpy), N,N,N′,N″,N″-pentamethyldiethylenetriamine (PMDETA), N,N-bis(2-pyridylmethyl)octylamine (BPMOA), 1,1,4,7,10,10-hexamethyltriethylenetetramine (HMTETA), tris[2-(dimethylamino)ethyl]amine (Me₆TREN), tris[(2-pyridyl)methyl]amine (TPMA), 1,4,8,11-tetraaza-1,4,8,11-tetramethylcyclotetradecane (Me4CYCLAM), and N,N,N′,N′-tetrakis(2-pyridylmethyl)ethylenediamine (TPEN).

14. The method of claim 1, wherein the chain transfer agent is AlR₃, where each R is independently (C₁-C₁₂)alkyl.

15. The method of claim 1, wherein heating the polymeryl aluminum species produces the vinyl-terminated polyolefin via a beta-elimination reaction.

16. The method of claim 1, wherein the linker has a structure according to formula (II): 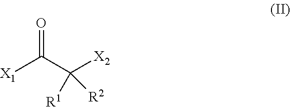
where X₁ is a halogen atom; X₂ is chlorine, bromine or iodine; and R¹ and R² are independently (C₁-C₂₀)hydrocarbyl.

17. The method of claim 1, wherein the non-polar-polar diblock copolymer is a polyolefin-polyacrylate diblock copolymer.

18. The method of claim 1, wherein the non-polar-polar diblock copolymer is a polyethylene-polyacrylate diblock copolymer.
